(19) United States
(12) Patent Application Publication
(10) Pub. No.: US 2026/0277052 A1
(43) Pub. Date: Sep. 17, 2026

(54) Manganese-Based Self-Forming Barrier Layer for Stack-Integrated Metasurface Devices and Sequential Damascene Manufacturing

(71) Applicant: Lumotive, Inc., Redmond, WA (US)

(72) Inventors: Gleb M. Akselrod, Kenmore, WA (US); Mark C. Weidman, Renton, WA (US); Erik Edward Josberger, Renton, WA (US); Lie Larry Zhao, Washougal, WA (US); Linda Gail Conway, Duvall, WA (US); Jiawei Zuo, Renton, WA (US)

(73) Assignee: Lumotive, Inc., Redmond, WA (US)

(21) Appl. No.: 19/540,537

(22) Filed: Feb. 13, 2026

Related U.S. Application Data
(63) Continuation-in-part of application No. 18/642,422, filed on Apr. 22, 2024.
(60) Provisional application No. 63/760,532, filed on Feb. 19, 2025.

(51) Int. Cl. G02F 1/1335; G02B 1/00; G02B 26/00

(52) U.S. Cl. CPC G02F 1/133565; G02B 1/002; G02B 26/001

(57) ABSTRACT

The disclosure includes an optical metasurface with an optical reflector layer and a resonator layer. The resonator layer includes an array of optical resonators that extend vertically relative to the optical reflector layer. Each optical resonator may be formed by two stack-integrated metallic optical elements positioned adjacent to each other, creating a gap. The stack-integrated metallic optical elements may include a base metallic optical element and one or more stacked metallic optical elements. The base metallic optical element is formed via a first single-damascene process with a tantalum-based barrier layer. Each stacked metallic optical element is formed via a successive single-damascene process with a manganese-based self-forming barrier layer.

### RELATED APPLICATIONS

This patent application claims priority to and benefit under 35 U.S.C. § 119 to U.S. Provisional Patent App. No. 63/760,532, filed Feb. 19, 2025, titled “Manganese-Based Self-Forming Barrier Layer for Stack-Integrated Metasurface Devices and Sequential Damascene Manufacturing,” and is a Continuation-in-Part of U.S. Patent Application No. 18/642,422, filed on Apr. 22, 2024, titled “Stack-Integrated Metasurface Devices and Sequential Damascene Manufacturing Processes,” each of which is hereby incorporated by reference in its entirety. This application is also related to U.S. Patent Application No. 19/290,298, filed Aug. 4, 2025, titled “Active-Matrix Tunable Metasurface with Ring-Aperture Resonators,” which is hereby incorporated by reference in its entirety.

### TECHNICAL FIELD

This disclosure relates to optical metasurfaces, including tunable optical metasurfaces. More specifically, this disclosure relates to metasurfaces incorporating one-dimensional and two-dimensional arrays of tunable optical resonators.

### BRIEF DESCRIPTION OF THE DRAWINGS

FIG. 1 illustrates an example of a metasurface that is steerable in one dimension, according to one embodiment.

FIG. 2 illustrates a perspective view of a simplified block diagram of reflective and resonator layers of a two-dimensional optical metasurface, according to one embodiment.

FIG. 3 illustrates a side-view diagram of the layers of a portion of a tunable optical metasurface, according to one embodiment.

FIG. 4A illustrates an example diagram of two anti-nodes of an optical field in an optical resonator of a tunable optical metasurface, according to one embodiment.

FIG. 4B illustrates the tunable dielectric material between two pillars aligned in a first direction to provide a first refractive index without any applied voltage, according to one embodiment.

FIG. 4C illustrates a tunable dielectric material between the pillars, aligned in a second direction, to provide a second refractive index when an applied voltage of 5 volts is applied, according to one embodiment.

FIG. 4D illustrates a graph of a phase response of the optical resonator of FIG. 4A with respect to applied voltage values, according to one embodiment.

FIG. 5A illustrates an example diagram of three anti-nodes of an optical field in an optical resonator with a relatively high aspect ratio, according to one embodiment.

FIG. 5B illustrates a graph of a phase response of the optical resonator of FIG. 5A with respect to applied voltage values, according to one embodiment.

FIG. 6A illustrates an example diagram of six anti-nodes of an optical field in an optical resonator with an even higher aspect ratio, according to one embodiment.

FIG. 6B illustrates a graph of a phase response of the optical resonator of FIG. 6A with respect to applied voltage values, according to one embodiment.

FIG. 7A illustrates a metallic via within the via layer to connect a reflector of the reflector layer to a metallic optical element of the optical resonator layer, according to one embodiment.

FIGS. 7B-7G illustrate block diagrams of a single-damascene process to form a base metallic optical element of a stack-integrated optical resonator, according to one embodiment.

FIGS. 8A-8G illustrate a single-damascene process to form a stacked metallic optical element using a self-forming barrier, according to one embodiment.

FIG. 9 illustrates an example of a high-aspect-ratio optical resonator formed with stack-integrated metallic optical elements formed using a self-forming barrier, according to one embodiment.

FIG. 10 illustrates a perspective view of a simplified block diagram of a metasurface that is steerable in one dimension with stack-integrated metallic optical elements forming high-aspect ratio optical resonators, according to one embodiment.

FIG. 11A illustrates a perspective view of a simplified block diagram of a metasurface with stack-integrated metallic optical elements that form high-aspect-ratio optical resonators, according to one embodiment.

FIG. 11B illustrates another perspective view of a simplified block diagram of a metasurface with stack-integrated metallic optical elements that form high-aspect-ratio optical resonators, according to one embodiment.

FIG. 12A illustrates a perspective view of a simplified block diagram of ring-aperture resonators, conductive vias, and rectangular resonators, according to one embodiment.

FIG. 12B illustrates a perspective view of a simplified block diagram of ring-aperture resonators with square pillars, according to one embodiment.

FIG. 12C illustrates a perspective view of a simplified block diagram of ring-aperture resonators with rounded-edge rectangular pillars, according to one embodiment.

FIG. 13A illustrates a cross-sectional view of a ring-aperture resonator and a ring-aperture reflector, according to one embodiment.

FIG. 13B illustrates a perspective cut-away view of a ring-aperture resonator and a ring-aperture reflector, according to one embodiment.

FIG. 14A illustrates a cross-sectional diagram of a ring-shaped optical field within a tunable dielectric material in an annular gap of a ring-aperture resonator, according to one embodiment.

FIG. 14B illustrates the optical fields of a ring-aperture resonator in the on and off states, according to one embodiment.

FIG. 14C illustrates a cross-sectional diagram of a ring-shaped optical field within the tunable dielectric material in an annular gap of a ring-aperture resonator, according to one embodiment.

FIG. 14D illustrates a cross-sectional diagram of a ring-shaped optical field within the tunable dielectric material in an annular gap of a stack-integrated ring-aperture resonator with a higher aspect ratio, according to one embodiment.

FIGS. 15A-G illustrate block diagrams of a single-damascene process to form a base metallic optical element of a stack-integrated ring-aperture optical resonator, according to one embodiment.

FIGS. 15H-M illustrate block diagrams of a single-damascene process to form a stacked ring-aperture metallic optical element using a self-forming barrier, according to one embodiment.

FIG. 15N illustrates a high-aspect-ratio ring-aperture optical resonator comprising stack-integrated metallic optical elements fabricated with a self-forming barrier, according to one embodiment.

FIG. 16 illustrates a perspective view of a simplified block diagram of a metasurface with stack-integrated metallic optical elements that form high-aspect-ratio ring-aperture optical resonators, according to one embodiment.

### DETAILED DESCRIPTION

According to various embodiments, a metasurface includes a one-dimensional or two-dimensional array of optical resonators. The metasurface may include an optical reflector layer to reflect electromagnetic radiation within an operational bandwidth, a resonator layer with optical resonators extending vertically therein, and an interconnect layer with metallic vias to selectively connect metallic optical elements of the optical resonators to reflector patches of the reflector layer. In various embodiments, the optical reflector layer includes a plurality of metallic reflector patches (e.g., copper). In various embodiments, each optical resonator in the resonator layer is formed by two vertically oriented, stack-integrated metallic optical elements (e.g., copper) positioned adjacent to one another, creating a gap between them. In various embodiments, the interconnect layer is positioned between the optical reflector layer and the resonator layer and includes a plurality of metallic vias. Each metallic via may, for example, electrically connect one of the metallic optical elements in the resonator layer to one of the metallic reflector patches in the optical reflector layer.

According to various examples, each stack-integrated metallic optical element includes at least a base metallic optical element and one or more stacked metallic optical elements. The base metallic optical element of each stack-integrated metallic optical element may be formed during a first single-damascene manufacturing process. In some embodiments, the base metallic optical element of each stack-integrated metallic optical element may be formed during a dual-damascene manufacturing process. In such embodiments, the dual-damascene manufacturing process may be used to form the base metallic optical elements together with the vias in an underlying interconnect or via layer. Each subsequent stacked metallic optical element may be formed as part of a sequence or series of distinct single-damascene manufacturing processes. Each stack-integrated metallic optical element may extend to a height that is at least four times greater than the smallest width thereof, such that each stack-integrated metallic optical element has an aspect ratio of at least 4:1.

For example, the base metallic optical element of each stack-integrated metallic optical element may have an aspect ratio of at least 3:1, and the first stacked metallic optical element of each stack-integrated metallic optical element may have an aspect ratio of at least 2:1, such that each stack-integrated metallic optical element has an aspect ratio of at least 5:1. In another example, a base metallic optical element, a first stacked metallic optical element, and a second stacked metallic optical element each have an aspect ratio of at least 2:1, such that the triple-stacked stack-integrated metallic optical element has an aspect ratio of at least 6:1.

In other embodiments, the stack-integrated metallic optical elements have smaller aspect ratios, such as 1.5:1, 2:1, 3:1, or 4:1, even when more than one stacked metallic optical element is on a base metallic optical element. For example, a metasurface may comprise stack-integrated metallic optical elements that have an aspect ratio of 2:1, where the base metallic optical element has a height-to-width aspect ratio of 1:1, and a stacked metallic optical element also has an aspect ratio of 1:1. In another embodiment, a metasurface may comprise stack-integrated metallic optical elements that have an aspect ratio of 2:1, where the base metallic optical element has a height-to-width aspect ratio of 1.25:1, and a stacked metallic optical element has an aspect ratio of 0.75:1. More generally, any target aspect ratio M:N may be achieved with a base metallic optical element and any number of stacked metallic optical elements.

In some embodiments, the manufacturing process uses a manganese-based self-forming barrier (Mn-SFB) to address challenges associated with high-aspect-ratio structures in optical metasurfaces. The Mn-SFB may comprise a copper-manganese alloy. For example, the Mn-SFB may be described as a manganese-based self-forming barrier that is at least 75% copper (e.g., approximately 90% copper and 10% manganese). This approach enables void-free copper filling by leveraging the unique properties of manganese diffusion during post-plating annealing. Specifically, the Mn-SFB forms a thin, self-limiting manganese-silicon-oxide (MnSiOx) layer (approximately 2–3 nm) along the sidewalls of the copper structures. The Mn-SFB layer prevents subsequent diffusion of the copper into the surrounding dielectric, prevents further diffusion of manganese, and contributes to a robust mechanical and electrical connection between the base metallic optical element and the stacked metallic optical element.

The annealing process, typically performed at temperatures between 200°C and 375°C, allows manganese to migrate preferentially to oxygen-rich regions, such as the silicon dioxide or tetraethyl orthosilicate (TEOS), forming a stable barrier layer. This process eliminates the need for tantalum-based barriers in the stacked, upper layers, thereby reducing electrical resistance, increasing reflectivity, and simplifying integration. Moreover, during annealing, the manganese between the stacked copper optical elements migrates away from the region, leaving behind copper that joins the stacked copper optical elements into a continuous optical element. Unlike conventional processes, which struggle with void formation and inadequate seed-layer coverage, sequential single-damascene processes with Mn-SFB layers in the stacked optical element layers enable defect-free copper structures with aspect ratios exceeding 4:1.

The base metallic optical element uses a tantalum-based barrier to ensure strong adhesion and mechanical support. The combination of tantalum at the base and Mn-SFB for subsequent layers provides a hybrid approach that balances mechanical integrity, reflectivity, and electrical performance in a high-aspect-ratio device.

The sequentially implemented single-damascene process with Mn-SFB layers for the second and subsequent stacked metallic optical elements enables scalability across numerous metasurface designs. By repeating the stacking process, additional layers can be integrated, enabling aspect ratios far beyond the capabilities of conventional approaches. This modularity makes the process particularly well-suited for metasurfaces that require precise beam steering and high optical efficiency, whether the optical elements are rails, pillars, cubes, or have another shape.

This disclosure may be understood by reference to the following detailed description, taken in conjunction with the drawings as described below. It is noted that, for purposes of illustrative clarity, certain elements in various drawings may not be drawn to scale, and other elements may be omitted to avoid obscuring the focus of this application.

Additional descriptions, variations, functionalities, and usages for optical metasurfaces are described in U.S. Patent No. 10,451,800 granted on October 22, 2019, entitled “Plasmonic Surface-Scattering Elements and Metasurfaces for Optical Beam Steering;” U.S. Patent No. 10,665,953 granted on May 26, 2020, entitled “Tunable Liquid Crystal Metasurfaces;” and U.S. Patent No. 11,092,675 granted on August 17, 2021, entitled “Lidar Systems based on Tunable Optical Metasurfaces,” each of which is hereby incorporated by reference in its entirety. Many of the metasurfaces described in the above-identified U.S. patents include one-dimensional arrays of parallel rails, two-dimensional arrays of elongated rails, and/or two-dimensional arrays of pillars positioned above a planar reflective surface, reflective layers, or optically transmissive surfaces.

This disclosure includes various embodiments and variations of tunable optical metasurface devices and methods for manufacturing the same. It is appreciated that the metasurface technologies described herein may incorporate or otherwise leverage prior advancements in surface scattering antennas, such as those described in U.S. Patent Publication No. 2012/0194399, published on August 2, 2012, entitled “Surface Scattering Antennas;” U.S. Patent Publication No. 2019/0285798 published on September 19, 2019, entitled “Plasmonic Surface-Scattering Elements and Metasurfaces for Optical Beam Steering;” and U.S. Patent Publication No. 2018/0241131 published on August 23, 2018, entitled “Optical Surface-Scattering Elements and Metasurfaces;” each of which is hereby incorporated by reference in its entirety. Additional elements, applications, and features of surface scattering antennas are described in U.S. Patent Publication No. 2014/0266946, published September 18, 2014, entitled “Surface Scattering Antenna Improvements;” U.S. Patent Publication No. 2015/0318618, published November 5, 2015, entitled “Surface Scattering Antennas with Lumped Elements;” U.S. Patent Publication No. 2015/0318620 published November 5, 2015, entitled “Curved Surface Scattering Antennas;” U.S. Patent Publication No. 2015/0380828 published on December 31, 2015, entitled “Slotted Surface Scattering Antennas;” U.S. Patent Publication No. 2015/0162658 published June 11, 2015, entitled “Surface Scattering Reflector Antenna;” U.S. Patent Publication No. 2015/0372389 published December 24, 2015, entitled “Modulation Patterns for Surface Scattering Antennas;” PCT Application No. PCT/US18/19269 filed on February 22, 2018, entitled “Control Circuitry and Fabrication Techniques for Optical Metasurfaces,” U.S. Patent Publication No. 2019/0301025 published on October 3, 2019, entitled “Fabrication of Metallic Optical Metasurfaces;” U.S. Publication No. 2018/0248267 published on August 30, 2018, entitled “Optical Beam-Steering Devices and Methods Utilizing Surface Scattering Metasurfaces;” U.S. Patent No. 11,429,008 granted on August 30, 2022, entitled “Liquid Crystal Metasurfaces with Cross-Backplane Optical Reflectors;” and U.S. Patent No. 11,960,155 granted on April 16, 2024, entitled “Two-Dimensional Metasurfaces with Integrated Capacitors and Active-Matrix Driver Routing,” each of which is hereby incorporated by reference in its entirety.

In various embodiments, the elongated metal rails, pillars, or other metallic extension structures (e.g., metallic optical elements) have subwavelength dimensions suitable for operation within a specific optical frequency band (e.g., infrared). The width of each metallic optical element may be, for example, less than the smallest wavelength of the operational bandwidth.

Tunable optical metasurfaces may be used for beamforming, including three-dimensional beam shaping, two-dimensional beam steering, and/or one-dimensional beam steering. The systems and methods described here can be applied to tunable metasurfaces with various architectures and designs to deflect optical radiation within their operational bandwidths. In various embodiments, a controller or a metasurface driver selectively applies a voltage pattern to an array of optical structures. Voltage differences across adjacent optical structures modify the refractive indices of the dielectric material between them. A combination of phase delays from the applied voltage pattern produces constructive interference in the desired beam-steering direction. The voltages, for example, are conveyed via metallic vias to the metallic optical elements that form the tunable optical resonators. In some embodiments, the metallic vias connect the metallic optical elements to reflector patches of the reflector layer. In such embodiments, the reflector patches are then connected to the control lines of a driver, capacitors, transistors, and/or other driver components to selectively drive voltage differentials across the various tunable optical resonators.

Various examples of tunable optical metasurfaces are described herein and depicted in the figures. For example, a tunable optical metasurface includes an array of metal extension elements (e.g., antenna elements, resonator elements, elongated resonator rails, arrays of metal pillars, pairs of resonator pillars, etc.) that extend from a dielectric substrate above a metallic reflector. For instance, in some embodiments, the array of metal elements comprises a one-dimensional array of elongated metal resonator rails arranged parallel to one another relative to an optical reflector, such as an optically reflective metal layer or a Bragg reflector. Liquid crystal, or another refractive index tunable dielectric material, is positioned in the gaps or channels between adjacent resonator rails (e.g., adjacent elongated metal rails). Liquid crystal is used in many of the examples provided in this disclosure. However, it is appreciated that an alternative dielectric material with a tunable refractive index/or combinations of different dielectric materials with tunable refractive indices, may be used instead of liquid crystal. Examples of suitable tunable dielectric materials with tunable refractive indices include liquid crystals, electro-optic polymers, chalcogenide glasses, and various semiconductor materials.

In various embodiments, biasing the liquid crystal in a metasurface with a patterned voltage distribution changes the phase of reflected optical radiation. For example, each different voltage pattern applied across the metasurface corresponds to a different reflection phase pattern. Each distinct reflection-phase pattern of a one-dimensional array of optical structures (e.g., elongated metal resonator rails) corresponds to a different steering angle along a single dimension. A digital or analog controller (controlling current and/or voltage), such as a metasurface driver, may apply a differential-voltage bias pattern to achieve a target beam-shaping objective, such as a target beam-steering angle. The term “beam shaping” is used herein in a broad sense to encompass one-dimensional beam steering, two-dimensional beam steering, wavelength filtering, beam divergence, beam convergence, beam focusing, and/or controlled deflection, refraction, and/or reflection of incident optical radiation.

Various examples and metal elements, such as elongated metal rails and metal pillars, are illustrated and described in many instances as being copper or as including copper (e.g., a copper alloy). Copper antenna elements may, for example, be fabricated using sequential single-damascene processes for semiconductor devices. However, other metals may also be used, including but not limited to tungsten, aluminum, copper alloys, and/or combinations thereof.

Any of the variously described embodiments herein may be manufactured with dimensions suitable for optical bandwidths for optical sensing systems such as LiDAR, optical communications systems, optical computing systems, and displays. For example, the systems and methods described herein can be configured with metasurfaces that operate in the sub-infrared, mid-infrared, high-infrared, and/or visible-frequency ranges (collectively, “optical”). Given the feature sizes needed for sub-wavelength optical antennas and antenna spacings, the described metasurfaces may be manufactured using micro-lithographic and/or nano-lithographic processes, such as fabrication methods commonly used to manufacture complementary metal-oxide-semiconductor (CMOS) integrated circuits.

The components of some of the disclosed embodiments are described and illustrated in the figures herein to provide specific examples. Many portions thereof could be arranged and designed in a wide variety of different configurations. Furthermore, the features, structures, and operations associated with one embodiment may be applied to or combined with the features, structures, or operations described in conjunction with another embodiment. In many instances, well-known structures, materials, or operations are not shown or described in detail to avoid obscuring aspects of this disclosure. The right to add any described embodiment or feature to any one of the figures and/or as a new figure is explicitly reserved.

The embodiments of the systems and methods provided within this disclosure are not intended to limit the scope of the disclosure but are merely representative of possible embodiments. In addition, the steps of a method need not be executed in any specific order or even sequentially, nor need they be executed only once, except as explicitly stated or as contextually understood by one of skill in the art.

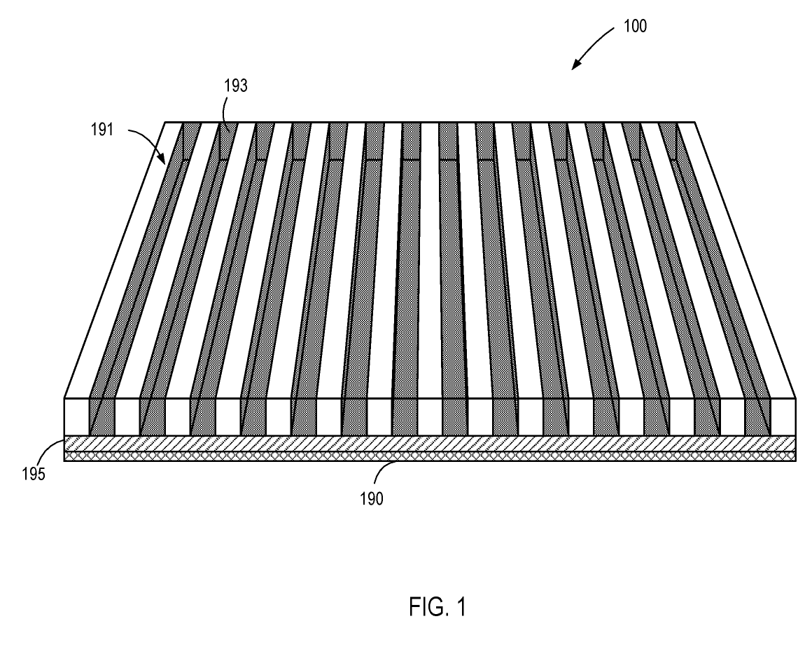

FIG. 1 illustrates an example of a metasurface 100 that is steerable in one dimension, according to various embodiments. The tunable metasurface 100 can, for example, be used as part of a solid-state optical transmitter subsystem, receiver subsystem, or transceiver system of a software-defined lidar device. As illustrated, the tunable metasurface 100 includes an optically reflective substrate 190 and a dielectric layer 195. A plurality of elongated rails 191 may be arranged at sub-wavelength intervals on the optically reflective substrate 190. Liquid crystal or another refractive index tunable dielectric material 193 may be positioned between the elongated rails 191, as described in the context of the various metasurfaces described in the references incorporated herein by reference. The metasurface 100 can be used for beam steering in one direction, so that incident optical radiation can be selectively steered to various angles (e.g., as scan lines steered along a single axis).

The reflection phase of the elongated rails 191 is sensitive to the refractive index of the core material, which phase modulation of 2π or nearly 2π using an index modulation of Δn/n of about 7%. The high sensitivity to the refractive index of the core material is enabled by the high Q of the resonance, for example, a Q of 20. The high sensitivity of the reflection phase to the core refractive index enables the integration of refractive-index-tunable core material into the gaps between metal elements, creating dynamic metasurfaces.

High-Q, low-loss, subwavelength resonators can enable smaller refractive-index modulation ranges in tunable dielectric materials. The Q factor is a dimensionless parameter that characterizes a resonator’s bandwidth relative to its center frequency. A high Q factor indicates a lower rate of energy loss relative to the stored energy of the resonator. Resonators with high Q factors have low damping. The optically reflective substrate 190 may be built upon underlying layers, such as a wafer substrate and layers for wires, routing, vias, capacitors, control devices, transistors, driver elements, etc., as described in the patent applications incorporated herein by reference.

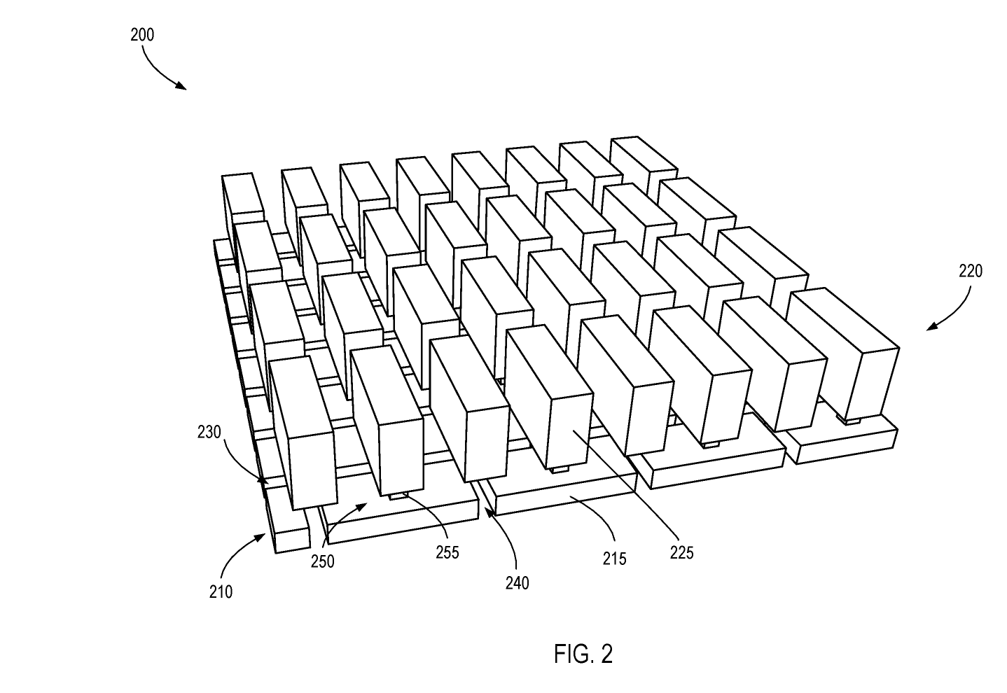

FIG. 2 illustrates a perspective view of a simplified block diagram of a reflective layer 210 and resonator layer 220 of a two-dimensional optical metasurface 200, according to one embodiment. As illustrated, the resonator layer 220 includes a two-dimensional array of metallic optical pillars 225 arranged in parallel rows. Each pillar 225 in the resonator layer 220 extends vertically relative to an underlying substrate layer (not shown) and is shaped as a rectangular prism (e.g., a rectangular cuboid). The pillars 225 in each row may be spaced from one another by less than the smallest wavelength in an operational bandwidth. The width (W) of each pillar 225 along each row may be less than one-half of the smallest wavelength of the operational bandwidth. The length (L) of each pillar 225 in a direction perpendicular to each row (e.g., along the columns) may be less than the smallest wavelength of the operational bandwidth.

The gaps between adjacent pillars 225 in each row of pillars form optical resonators. A tunable dielectric material may be deposited within the resonator layer to fill the spaces between the pillars 225 in all directions, such that the tunable dielectric material is positioned within the optical resonators formed by the gaps between row-adjacent pillars 225. Examples of suitable tunable dielectric materials with tunable refractive indices include liquid crystals, electro-optic polymers, electro-optic crystals, chalcogenide glasses, and/or various semiconductor materials.

In alternative embodiments, the pillars 225 in each row may be spaced from one another by more than a wavelength within the operational bandwidth (e.g., by a factor of 10 times the largest wavelength in the operational bandwidth). Similarly, in some embodiments, the width (W) of each pillar 225 along each row may be more than one-half of the smallest wavelength, and the length (L) of each pillar 225 in a direction perpendicular to each row (e.g., along the columns) may be many times larger than the largest wavelength of the operational bandwidth.

The reflective layer 210 includes a two-dimensional array of elongated rectangular reflector patches 215 extending lengthwise along parallel rows. That is, as illustrated, the reflector patches 215 extend lengthwise in a direction perpendicular to the lengthwise direction of the pillars 225. An electrical isolation gap 230 separates reflector patches 215 in adjacent rows. An off-resonance gap 240 separates adjacent reflector patches 215 in the same row. The direction of the electrical isolation gap 230 is off-resonance with the incident electric field, so there is no resonant coupling. The off-resonance gap 240 between adjacent reflector patches 215 is perpendicular to the incident electrical field. Accordingly, the off-resonance gap 240 is set to minimize or avoid resonance between reflector patches 215 in the same row across the range of optical radiation wavelengths. The off-resonance gap 240 may be different in size from the electrical isolation gap 230.

A dielectric via layer 250 may be positioned between the reflective layer 210 and the resonator layer 220. Each pillar 225 may be electrically connected to one underlying reflector patch 215 by a conductor via 255 within the dielectric via layer 250. The dielectric of the dielectric via layer 250 has been removed from the figure for clarity to show the positioning of the conductor vias 255. Additional examples and details related to two-dimensional tunable optical metasurfaces are described in U.S. Patent No. 11,846,865 titled “Two-dimensional Metasurface Beam Forming Systems and Methods,” granted on December 19, 2023, which application is incorporated herein by reference in its entirety.

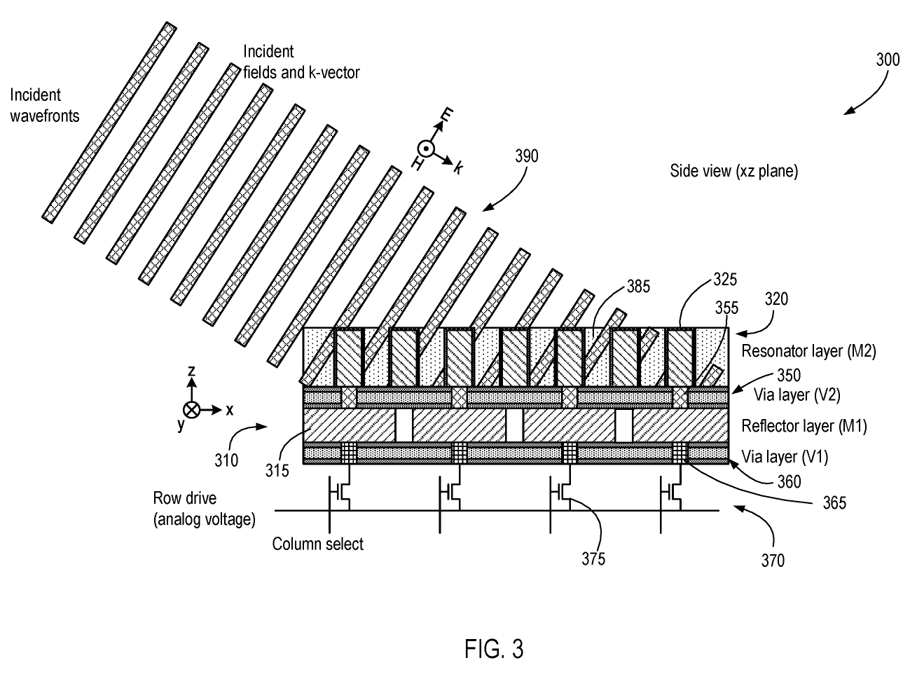

FIG. 3 illustrates a side-view diagram of the layers of a portion of a tunable optical metasurface 300 with active-matrix addressing, according to one embodiment. In the illustrated cross-sectional view, a single row of optical resonators is formed by the metallic optical pillars 325 in the resonator layer 320. The pillars 325 extend vertically relative to a substrate layer (not shown) and lengthwise into the page. A dielectric via layer 350 includes conductor vias 355 that connect the pillars 325 to reflector patches 315 within a reflective layer 310. As illustrated, the reflector patches 315 are staggered or offset with respect to one another such that the reflector patches 315 for every other pillar 325 are not visible in the cross-sectional view. The illustrated example includes a second via layer 360 with conductor vias 365 to connect the pillars 325 to the control lines and transistors 375 within the control layer 370.

The active-matrix architecture enables the resonant unit cells of the metasurface 300 to exhibit a unique pattern of phase responses (Φ) as functions of the row drive (x) and the column select (y), expressed as Φ = f(x, y). The incident fields and k-vector of the wavefront of the optical radiation 390 are depicted. The metasurface 300 may be used to achieve arbitrary phase modulation of the incident optical radiation 390 for beam steering, lensing, or other optical functionality.

As illustrated, the active matrix addressing scheme includes a transistor 375 beneath each resonant unit cell. In some embodiments, each resonant unit cell includes only a single transistor connected to one of the pillars, with the other pillar connected to a fixed voltage. In other embodiments, each resonant unit cell includes two transistors, with one transistor connected to each metallic optical pillar so that each metallic optical pillar can be driven with a unique voltage. While an absolute voltage is applied to each metallic optical pillar, the phase of each resonant unit cell depends on the voltage difference between adjacent metallic optical pillars.

According to various embodiments, the dielectric via layer 350 also functions as a waveguide layer in between the resonator layer 320 and the reflector layer 310. The thickness of the waveguide layer is such that the fields undergo destructive interference at the bottom of the optical resonator (e.g., at the gap between row-adjacent optical metallic pillars), thereby confining most of the optical energy to the vertical pillars, with minimal leakage into the waveguide layer.

The resonant unit cells are tuned by the refractive-index-tunable material 385 between adjacent metallic optical pillars 325. For example, liquid crystal, which has a wide refractive-index tuning range, may be used. As described herein, a differential voltage is applied between adjacent metallic optical pillars 325, which rotates the liquid crystals in that resonant unit cell, changing the refractive index experienced by the x component of the optical electric field. This consequently changes the effective length of the metallic optical pillars 325 and, hence, the phase experienced by the incident optical radiation 390 at that location on the metasurface. Since the resonant unit cells are resonant, phase changes are coupled to changes in the amplitude response in many embodiments, as is typical of Lorentz-type resonators. In such embodiments, each metallic optical pillar 325 is programmed with a unique voltage (hence, phase) to achieve the target spatial phase gradient. This gradient can be used for beam steering or for other optical functions, such as focusing, collimation, or arbitrary optical transformations.

Again, the metallic optical pillars 325 can be implemented in conventional CMOS manufacturing processes, such as copper damascene metallization, deposition, etching, lithography, patterning, chemical mechanical planarization, and the like. Other metals besides copper, such as aluminum, silver, and gold, can also be used to form the metal core of each metallic optical pillar. Copper is used in many embodiments because it is widely used in the semiconductor industry to make transistors and interconnects with the dimensions required to implement the resonant unit cells described herein. In addition, copper has excellent optical properties across the near-IR and short-wave IR wavelengths.

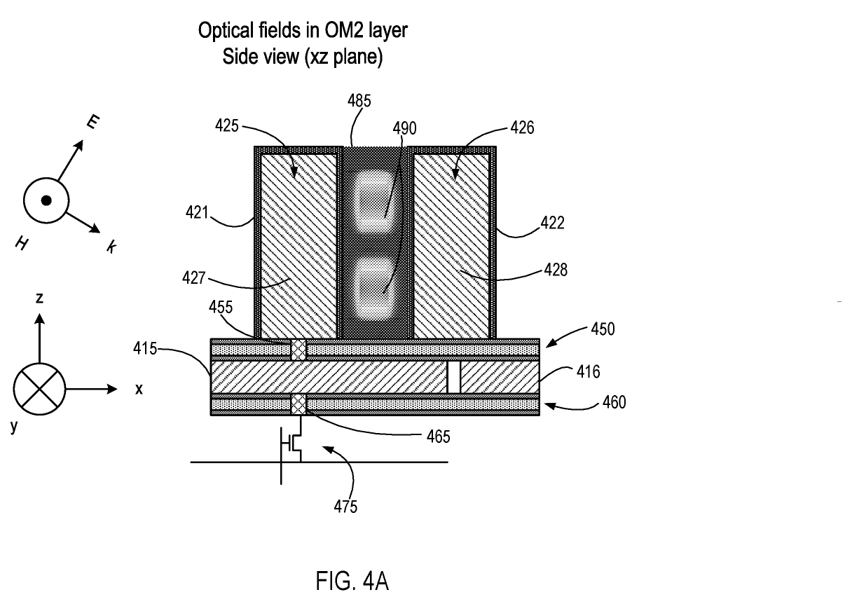

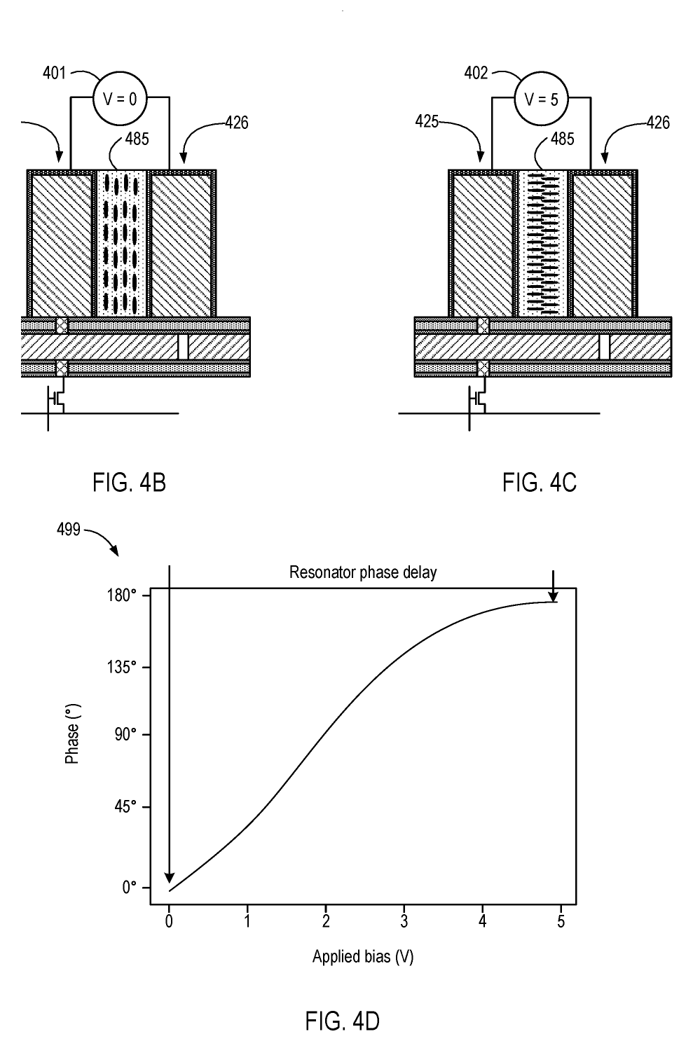

FIG. 4A illustrates a diagram of two anti-nodes 490 of the optical field within the tunable dielectric material 485 in the gap between a pair of metallic optical pillars 425 and 426, forming an optical resonator, with underlying reflector patches 415 and 416. In the illustrated example, the heights of the metallic optical pillars 425 and 426 are selected to achieve second-order resonance with two magnetic-field antinodes 490. For example, a ratio of the height to the width of each metallic optical pillar 425 and 426 for second-order resonance may be approximately 2.5:1 (or, alternatively, between approximately 2:1 and 3:1). According to various embodiments, and as illustrated, each metallic optical pillar 425 and 426 includes a metal core 427 and 428 and a passivation coating 421 and 422.

The exact dimensions of the metallic optical pillars 425 and 426 may be selected based on the system's operating wavelength. For example, the gap width between metallic optical pillars 425 and 426 may range from 50 nanometers to 300 nanometers, depending on the operating wavelengths (e.g., frequency or frequency band). In various embodiments, the width of each metallic optical pillar 425 and 426 is between 75 nanometers and 200 nanometers. Accordingly, the width of the optical resonator, or the device pitch, defined as the width of the two metallic optical pillars 425 and 426 and the width of the gap between them, may be between approximately 200 nanometers and 700 nanometers. To attain a 2.5:1 height-to-width aspect ratio, each metallic optical pillar 425 and 426 may have a height between approximately 187 nanometers and 500 nanometers, depending on the width of the metallic optical pillar.

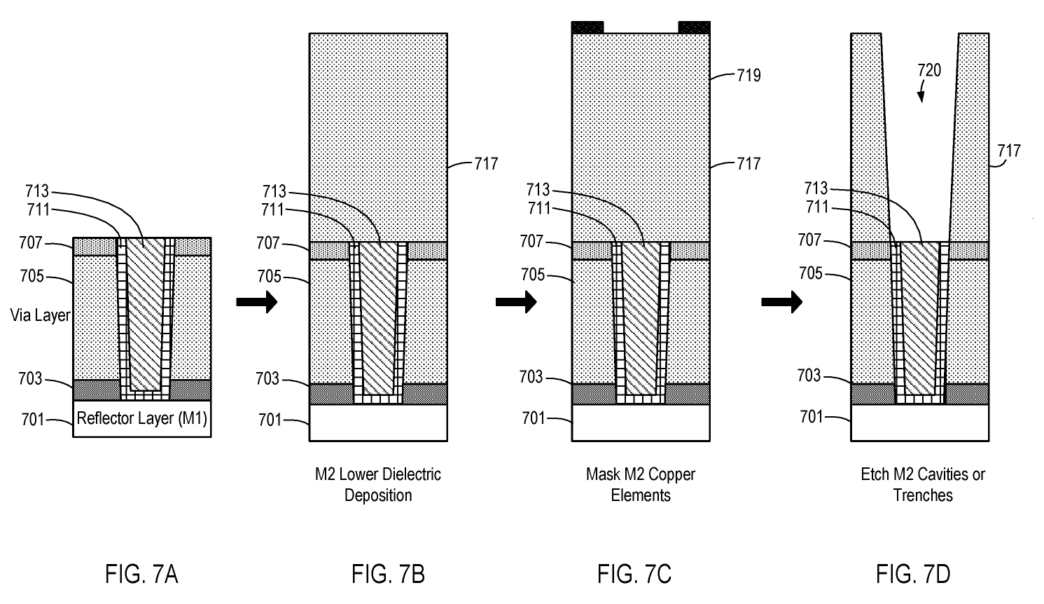

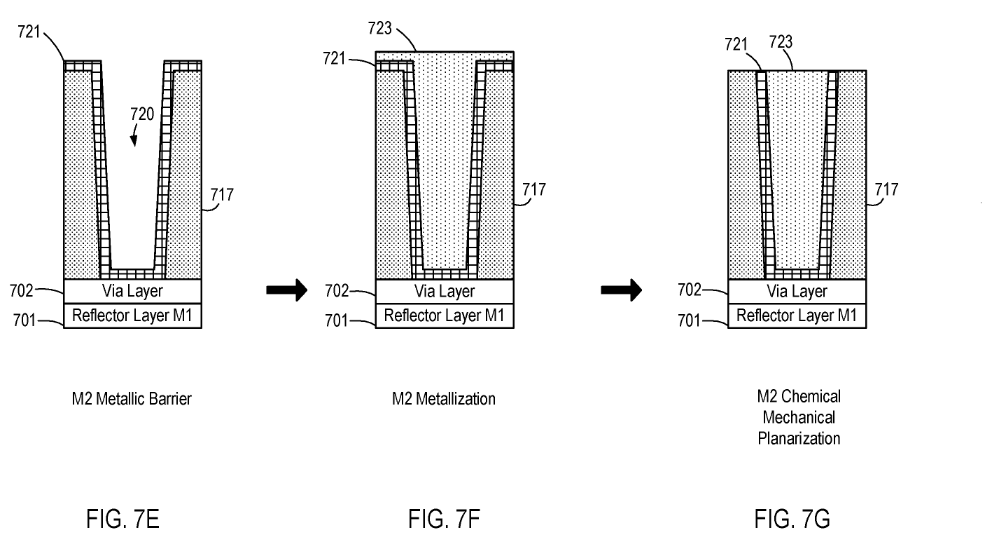

As described in the patent applications incorporated herein by reference, a two-dimensional array of metallic optical pillars may include metallic optical pillars that have rectangular cross sections, oval cross sections, polygonal cross sections, and/or other non-regular shapes. The pitch in one dimension of the metasurface may be different than the pitch in the other dimension of the metasurface. For example, in embodiments in which the resonator layer includes rectangular metallic optical pillars, the pitch in one dimension may be 500 nanometers, while the pitch in the other dimension may be 1000 nanometers (see, e.g., FIG. 7A of U.S. Patent No. 11,960,155).

The passivation coating(s) 421 and 422 may be deposited as multiple layers or as a single, uniform layer covering the sidewalls and top wall of each metallic optical pillar 425. The passivation coating(s) 421 and 422 may, for example, be a thin silicon nitride (SiN) layer to passivate the metal core (s) 427 and 428 of each metallic optical pillar 425. The passivation coating(s) 421 and 422 may prevent diffusion of the metal of the metallic optical pillars 425 and 426 into the tunable dielectric material (e.g., liquid crystal) and/or prevent corrosion of the metallic optical pillars 425 and 426. The passivating coating 421 and 422 may be SiN, SiCN, aluminum oxide, or another suitable passivation material.

The passivation coating 421 and 422 may be optically transparent for wavelengths within the operational bandwidth of the metasurface and/or reflective to complement the underlying reflective conductive metal core 427 and 428 (e.g., copper). The passivation coating 421 and 422 may alternatively (or additionally) include silicon carbide nitride, silicon carbide, aluminum oxide (AlOₓ), hafnium oxide (HfO₂, silicon oxide (SiO₂), aluminum nitride (AlN), boron nitride (BN), and/or another passivating dielectric material. A transistor 475 within a control layer is connected to the pillar 425 via the reflector patch 415 and the intervening conductor vias 455 and 465 within the dielectric via layers 450 and 460. A controller can drive the pillar 425 to a target voltage via the transistor 475, creating a voltage differential across the optical resonator formed by the gap between pillars 425 and 426. The refractive index of the tunable dielectric material 485 may be adjusted to a target value based on the applied voltage difference between the pillars 425 and 426.

FIG. 4B illustrates the tunable dielectric material 485 between two pillars 425 and 426 aligned in a first direction to provide a first refractive index within the optical resonator without any applied voltage (e.g., zero-volt differential, at 401), according to one embodiment.

FIG. 4C illustrates the tunable dielectric material 485 between the pillars 425 and 426, aligned in a second direction, to provide a second refractive index within the optical resonator at 402, with an applied voltage of 5 volts, according to one embodiment.

FIG. 4D illustrates a graph 499 of the phase response of the optical resonator (resonant unit cell) with respect to applied voltage, according to one embodiment. It is appreciated that the phase response and range of voltages may vary based on the specific dimensions of the pillars 425 and 426, the width of the gap forming the optical resonator that is filled with the tunable dielectric material 485, and/or the specific material (e.g., liquid crystal) used as the tunable dielectric material 485. In the illustrated example, the second-order resonance with two magnetic-field antinodes allows a phase response of approximately 180 degrees.

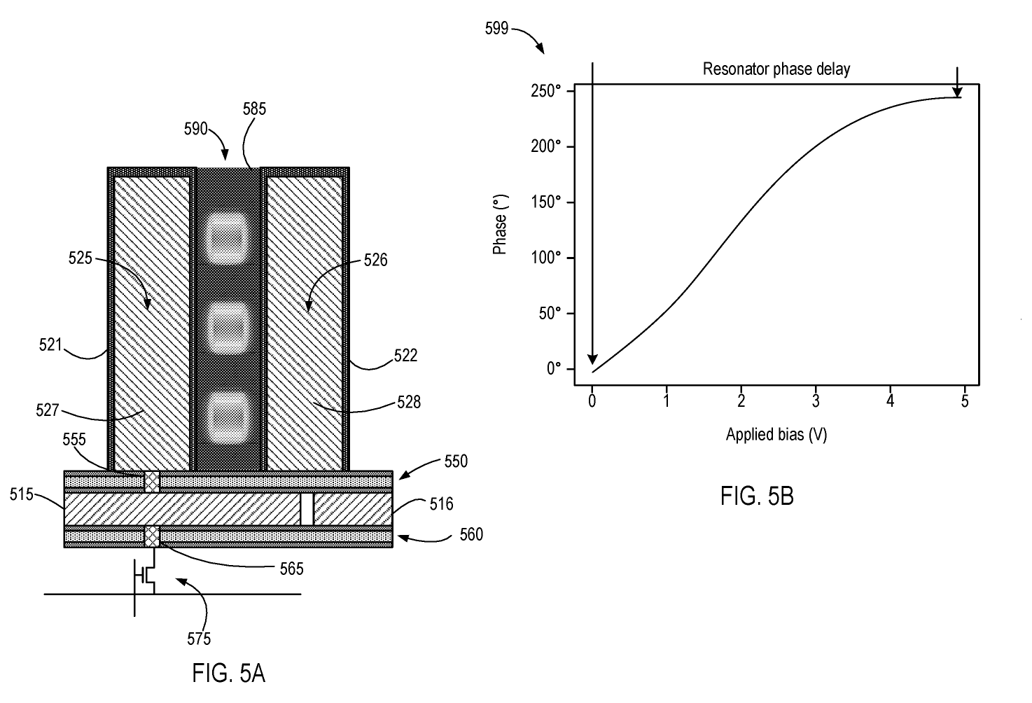

FIG. 5A illustrates an example diagram of three anti-nodes 590 of an optical field in an optical resonator with a relatively high aspect ratio, according to one embodiment. As illustrated, a tunable dielectric material 585 is positioned within the gap between a pair of metallic optical pillars 525 and 526 forming an optical resonator, with underlying reflector patches 515 and 516. In the illustrated example, the heights of the metallic optical pillars 525 and 526 are selected to achieve third-order resonance with three magnetic-field antinodes 590.

The ratio of the height to the width of each metallic optical pillar 525 and 526 for third-order resonance may be approximately 4:1. With a width between approximately 75 nanometers and 200 nanometers, the height of each metallic optical pillar 525 and 526 may be between approximately 300 nanometers and 800 nanometers. Again, the dimensions and the gap width between the metallic optical pillars 525 and 526 are determined by the device's operational wavelength (e.g., the center wavelength of its operational bandwidth).

As illustrated, each metallic optical pillar 525 and 526 includes a metal core 527 and 528 and a passivation coating 521 and 522. A transistor 575 within a control layer is connected to the metallic optical pillar 525 via the reflector patch 515 and the intervening conductor vias 555 and 565 within the dielectric via layers 550 and 560. A controller can drive the metallic optical pillar 525 to a target voltage via the transistor 575, creating a voltage differential within the optical resonator formed by the gap between the metallic optical pillars 525 and 526. The refractive index of the tunable dielectric material 585 may be adjusted to a target value based on the applied voltage difference between the metallic optical pillars 525 and 526.

FIG. 5B illustrates a graph 599 of a phase response of the optical resonator of FIG. 5A with respect to applied voltage values, according to one embodiment. Again, it is appreciated that the phase response and range of voltages may vary based on the specific dimensions of the pillars 525 and 526, the width of the gap forming the optical resonator that is filled with the tunable dielectric material 585, and/or the specific material (e.g., liquid crystal) used as the tunable dielectric material 585. Assuming all other variables are held constant with respect to the embodiment described in conjunction with FIGS. 4A-4D, the optical resonator with third-order resonance and three magnetic-field anti-nodes allows for a phase response of approximately 250 degrees.

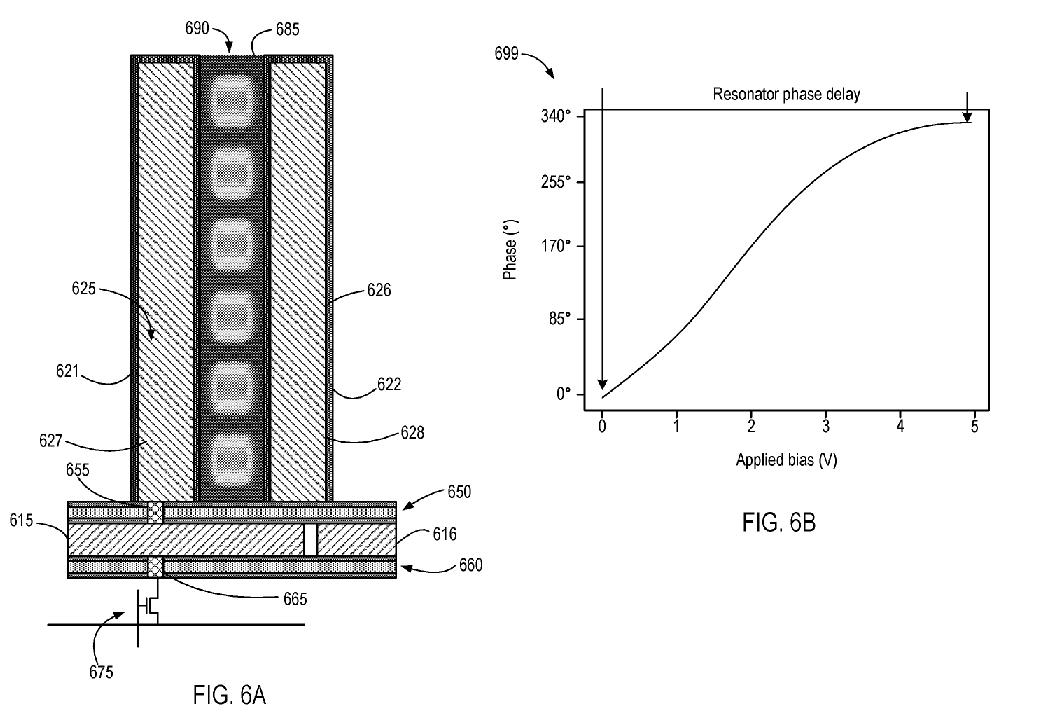

FIG. 6A illustrates an example diagram of six anti-nodes 690 of an optical field in an optical resonator with an even higher aspect ratio, according to one embodiment. A tunable dielectric material 685 is positioned within the gap between a pair of metallic optical pillars 625 and 626 forming an optical resonator, with underlying reflector patches 615 and 616. In the illustrated example, the heights of the metallic optical pillars 625 and 626 are selected to achieve sixth-order resonance with six magnetic-field antinodes 690 within the high-aspect-ratio channel or gap between the metallic optical pillars 625 and 626.

The ratio of the height to the width of each metallic optical pillar 625 and 626 for six-order resonance may be, for example, between approximately 7:1 and 8:1. Using metallic optical pillars 625 and 626 having widths of approximately 75-200 nanometers, the height of each metallic optical pillar 625 and 626 may be between approximately 525 nanometers and 1,600 nanometers. Again, the dimensions and the gap width between the metallic optical pillars 625 and 626 are determined by the device's operational wavelength (e.g., the center wavelength of its operational bandwidth).

As previously described, each metallic optical pillar 625 and 626 may include a metal core 627 and 628 and a passivation coating 621 and 622. A transistor 675 within a control layer may be connected to the metallic optical pillar 625 via the reflector patch 615 and the intervening conductor vias 655 and 665 within the dielectric via layers 650 and 660. A controller can drive the metallic optical pillar 625 to a target voltage via the transistor 675 to create a voltage differential within the optical resonator formed by the gap between the metallic optical pillars 625 and 626. The refractive index of the tunable dielectric material 685 may be adjusted to a target refractive index based on the applied voltage differential between the metallic optical pillars 625 and 626. Alternative driver schemas and configurations and/or alternative reflective layer layouts may be utilized.

FIG. 6B illustrates a graph 699 of a phase response of the optical resonator of FIG. 6A with respect to applied voltage values, according to one embodiment. It is appreciated that the phase response and range of voltages may vary based on the specific dimensions of the pillars 625 and 626, the width of the gap forming the optical resonator that is filled with the tunable dielectric material 685, and/or the specific material (e.g., liquid crystal) used as the tunable dielectric material 685. Assuming all other variables are held constant with respect to the embodiment described in conjunction with FIGS. 4A-4D and FIGS. 5A-5B, the optical resonator with sixth-order resonance and six magnetic field anti-nodes allows for a phase response of approximately 340 degrees.

FIG. 7A illustrates a metallic via 713 within the a via or interconnect layer that connect a reflector of the reflector layer 701 (M1) to a metallic optical element of the optical resonator layer (M2), according to one embodiment. The metallic via 713 may be, for example, formed using the process described in U.S. Patent Application 18/423,218 filed on January 25, 2024, titled “Metasurface Devices and Manufacturing Using Sequential Single-Damascene Processes with Protective Dielectric Cap Layers,” which application is hereby incorporated by reference in its entirety. As described herein and in the related applications incorporated herein by reference, any number of other layers may be positioned between a substrate layer and the reflector layer 701. The reflector layer 701 may be embodied as, for example, a planar reflector layer with vias formed therein, a crisscross pattern of reflector strips with gaps therebetween to serve as vias, and/or as a plurality of reflector patches. For instance, the reflector layer 701 may include metallic reflector patches positioned within or between dielectric layers.

In addition to the metallic via 713, the via layer may include an etch-stop layer 703, a dielectric mid-layer 705, and a dielectric cap layer 707. The metallic via 713 (e.g., copper) may be separated from dielectric layers (e.g., etch-stop layer 703, dielectric mid-layer 705, and dielectric cap layer 707) by a metallic barrier 711, as described in the applications incorporated herein by reference. The first metallic barrier 711 may comprise, for example, one or more of tantalum (Ta), tantalum nitride (TaN), and titanium nitride (TiN). The etch-stop layer 703 may, for example, be silicon nitride. The dielectric mid-layer 705 may, for example, be tetraethyl orthosilicate (TEOS) or another dielectric material. The selection of the specific material used for the dielectric mid-layer 705 may depend on, or be selected with, a compatible etching technique (e.g., a buffered oxide etchant (BOE)).

The material for the dielectric cap layer 707 is selected to be resistant to the etching approach used in the subsequent single-damascene process used to form the stack-integrated optical resonators, as detailed herein. For example, the dielectric cap layer 707 may be an etch-resistant NBLoK® or BLOk® material available from Applied Sciences, Inc. The dielectric cap layer 707 may be a silicon carbide layer, alumina (Al₂O₃)_{,} a silicon nitride layer, a nitrogen-doped silicon carbide (NDC) layer, such as a layer, a silicon carbide deposited using plasma-enhanced chemical vapor deposition (PECVD) of trimethylsilane, and/or the like. In some embodiments, the dielectric cap layer 707 may include multiple sublayers, such as lower layer(s) and an upper layer. For example, the lower layer(s) of the dielectric cap layer 707 may comprise a silicon carbide layer, alumina (Al₂O₃)_{,} a silicon nitride layer, and/or a nitrogen-doped silicon carbide (NDC) layer. The upper layer of the dielectric cap layer 707 may comprise an etch-resistant NBLoK® or BLOk® material.

FIGS. 7B-7G illustrate block diagrams of a single-damascene process to form a base metallic optical element of a stack-integrated optical resonator, according to one embodiment. The single-damascene process used to form the base metallic optical element includes patterning steps, metallization (e.g., copper), and planarization (e.g., chemical-mechanical planarization, or “CMP”). The metallization may include a barrier deposition (e.g., tantalum), a seed deposition of the primary metal (e.g., copper), and electroplating of the primary metal (e.g., copper). The ratio of the height to the width of the base metallic optical element is referred to as the aspect ratio. The difficulty of manufacturing defect-free and/or void-free devices increases with the aspect ratio. For example, a single-damascene process may be limited to aspect ratios less than approximately 4:1, less than 2:1, or even less than 1:1, depending on a target profile and manufacturing process. While aspect ratios greater than 4:1 may be achieved, the quality of the barrier/seed step may suffer from coverage issues, voids may form, and/or other defects may arise. Higher-aspect-ratio devices (e.g., 4:1, 6:1, 8:1, 10:1, etc.) may be desirable in some applications to increase optical efficiency (e.g., via higher-order resonance) and/or reduce sidelobe transmission across various steering angles, directions, and beam shapes.

FIG. 7B illustrates the deposition of a resonator dielectric layer 717 to be etched to form a metallic optical element of an optical resonator in the resonator layer. The resonator dielectric layer 717 may, for example, be tetraethyl orthosilicate (TEOS) or another dielectric material suitable for etching. The selection of the material for the resonator dielectric layer 717 may depend on, or be selected alongside, a compatible etching technique (e.g., a buffered oxide etchant (BOE)).

FIG. 7C illustrates a resonator mask layer 719 added to control the etching of the resonator dielectric layer 717 down to the dielectric cap layer 707 (in some embodiments, a separate resonator etch-stop layer may be included as a layer above the dielectric cap layer 707, as detailed in the patent applications incorporated herein by reference.

FIG. 7D illustrates a cavity or channel 720 etched into the resonator dielectric layer 717 that stops at the dielectric cap layer 707, exposing the surface of the metallic via 713. The resonator mask layer 719 is removed after the etching is completed. In some embodiments, the etching process may include two or more stages that utilize different etching techniques. For example, a BOE wet etch may be used to etch down to a resonator etch-stop layer (not shown), after which a more precise or controlled etching technique may be used to carefully remove the resonator etch-stop layer (not shown) without damaging the underlying metallic via 713, the first metallic barrier 711, and/or the dielectric cap layer 707.

The dielectric cap layer 707 prevents the resonator etch step of the single-damascene process from destroying or otherwise damaging the dielectric material within the interconnect layer (via layer) or undercutting the sidewalls of the cavity or channel 720. Moreover, the dielectric cap layer 707 ensures that the shape of the already-formed metallic via 713 and the shape of the soon-to-be-formed metallic optical element are well-defined.

FIG. 7E illustrates a metallic barrier 721 deposited on the sidewalls and base of the cavity or channel 720. The metallic barrier 721, for example, prevents diffusion of the metal used to form the bulk of the metallic optical elements into the dielectric materials and/or prevents corrosion of the optical elements. The metallic barrier 721 may comprise, for example, one or more of tantalum (Ta), tantalum nitride (TaN), and titanium nitride (TiN). To avoid obscuring aspects of FIG. 7E and the subsequent drawings, the via layer 702 is hereafter shown in a simplified format, similar to the format used to represent the reflector layer 701.

FIG. 7F illustrates the bulk metal deposited within the cavity or channel 720 to form the metallic optical element 723. The process may include, for example, a metal seed deposition followed by electroplating. The seed deposition may include, for example, sputtering and/or vapor deposition.

FIG. 7G illustrates the use of chemical mechanical planarization (CMP) to finalize the formation of the metallic optical element 723 and remove the metallic barrier 721 that is outside of the cavity or channel 720. The metallic optical element 723 formed via the illustrated single-damascene process may have an aspect ratio of approximately 2:1 to 4:1 (approximately 2.5:1). In various embodiments, this aspect ratio may be suitable for second-order resonance at a given operational wavelength. For applications in which the low aspect ratio or medium aspect ratio elements are suitable, the resonator dielectric layer 717 and the metallic barrier 721 on the sidewalls of the metallic optical element 723 may be removed (e.g., etched) to expose the base metallic optical element 723. However, in applications in which a stack-integrated metallic optical element with a higher aspect ratio is desired, additional stacked metallic optical elements may be formed prior to etching, as described herein.

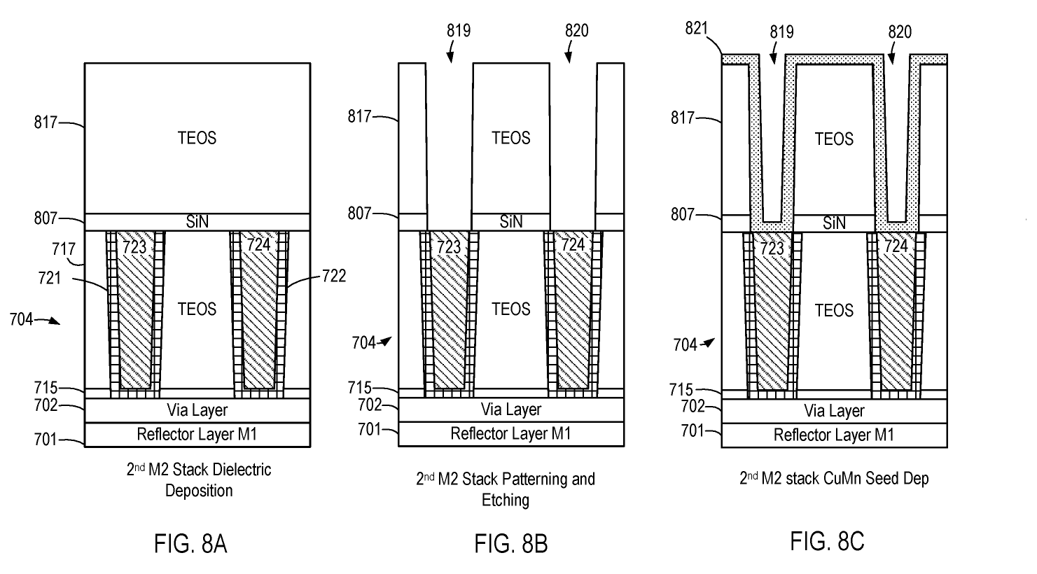

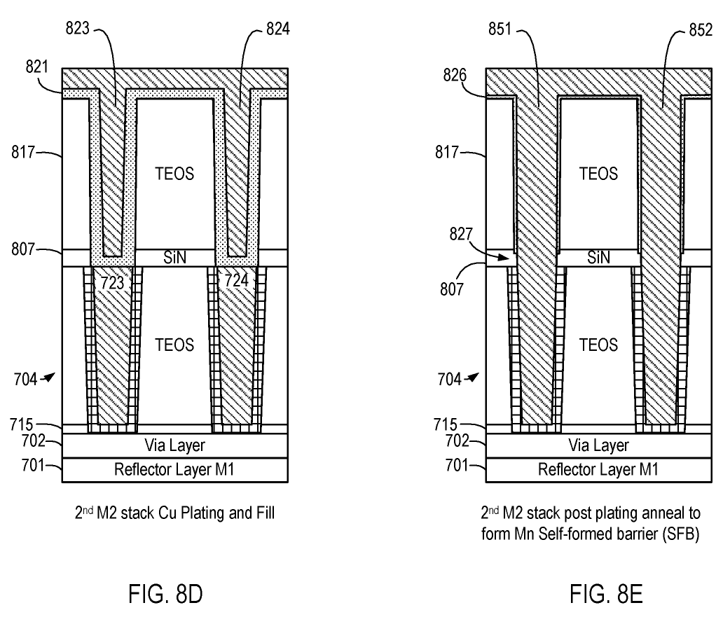

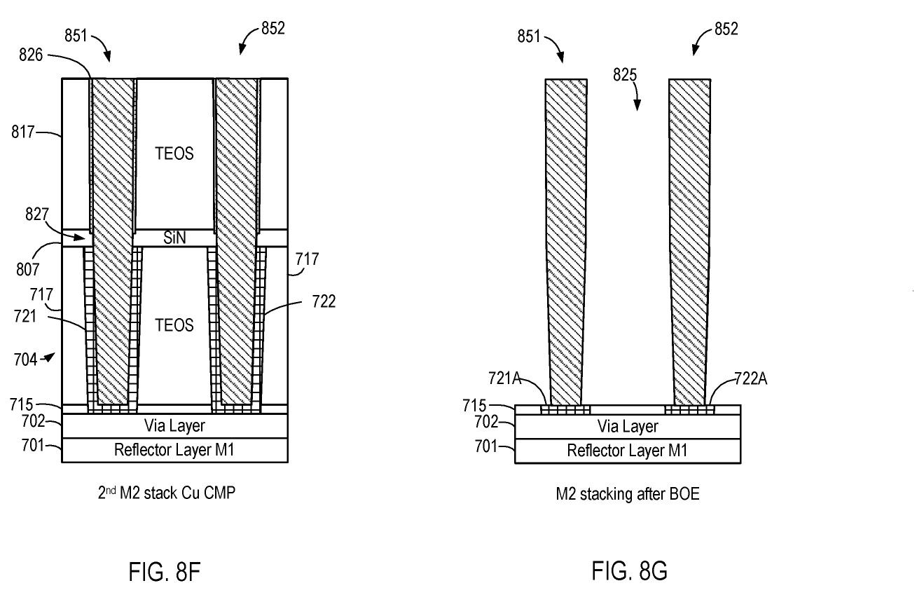

FIGS. 8A-8G illustrate a single-damascene process to form stacked metallic optical elements on the base metallic optical elements with a self-forming barrier (SFB), according to one embodiment. Specifically, a manganese-based SFB is used to form the stacked metallic optical elements on the base metallic optical elements. As detailed herein, devices can be manufactured to include stack-integrated metallic optical elements with height-to-width aspect ratios exceeding 4:1. Various approaches are described to manufacture high-aspect-ratio metallic optical elements using stacked optical resonator sections, each formed using a modified single-damascene process. FIGS. 8A-G illustrate one example of a stacked manufacturing process for high-aspect-ratio stack-integrated metallic optical elements.

FIG. 8A illustrates a stacked dielectric cap layer 807 and a stacked resonator dielectric layer 817 deposited on top of the base metallic optical element formation 704. As illustrated, the base metallic optical element formation 704 includes base metallic optical elements 723 and 724, metallic barriers 721 and 722, a resonator dielectric layer 717, and a resonator etch-stop layer 715. In various embodiments, the etch-stop layer 715 may be, for example, an etch-resistant NBLoK® or BLOk® material available from Applied Sciences, Inc. In various embodiments, the resonator etch-stop layer 715 may be omitted and/or be formed as an upper-most layer of the via layer 702 (e.g., as the dielectric cap layer 707 and/or a sublayer of the dielectric cap layer 707).

FIG. 8B illustrates cavities 819 and 820 (or extended channels) formed in the stacked resonator dielectric layer 817 and the stacked dielectric cap layer 807. As previously described, any of a wide variety of photoresists, masking processes, curing processes, and/or etching processes may be used to form the cavities 819 and 820.

FIG. 8C illustrates a copper-manganese alloy (Cu-Mn) barrier 821 formed on the sidewalls and the base walls of the cavities 819 and 820. For example, an electroless deposition technique may be used to deposit the copper-manganese alloy on the exposed surfaces (e.g., including the base and sidewalls of cavities 819 and 820). Alternative deposition techniques, such as sputtering or vapor deposition, may be used to form the copper-manganese alloy on the exposed surfaces. The copper-manganese alloy is referred to as a manganese-based barrier, or, after annealing as described below, as a manganese-based self-forming barrier (Mn-based SFB). In various embodiments, the copper-manganese alloy comprises approximately 90% copper and 10% manganese. The exact proportions of copper and manganese may vary between, for example, 75% and 95% copper and 5% and 25% manganese.

FIG. 8D illustrates the subsequent formation of stacked metallic optical elements 823 and 824. Stacked metallic optical elements 823 and 824 may be formed within the cavities 819 and 820 as stacked copper optical elements 823 and 824. The copper (or other metal) may be formed via a seed deposition (e.g., copper plating) step, followed by electroplating (or another plating process) to fill cavities 819 and 820 with copper (or another suitable metal or metal alloy).

FIG. 8E illustrates an annealing process applied to the device to form a Mn-Si-Oxide barrier 826 between the sidewalls of the stacked metallic optical elements 823 and 824 and the stacked resonator dielectric layer 817 (e.g., TEOS). During the annealing process, the manganese follows oxygen atoms to be diffused with a thickness of 1-5nm into the stacked resonator dielectric layer 817 (e.g., TEOS). The manganese in the region 827 between the stacked metallic optical element 823 and the base metallic optical element 723 is diffused away, leaving behind copper, resulting in a continuous stack-integrated metallic optical element 851. The manganese in the region between the stacked metallic optical element 824 and the base metallic optical element 724 is also diffused away, leaving behind the copper to form another continuous stack-integrated metallic optical element 852.

According to various embodiments, the annealing process may comprise applying heat in the range of approximately 200-400 Celsius, below the melting point of copper (e.g., 350 Celsius). The annealing temperature may be held for a sufficient time, depending on the specific temperature used, to form the Mn-Si-Oxide barrier 826 and the continuous stack-integrated metallic optical elements 851 and 852. The copper-manganese alloy (Cu-Mn) barrier 821 is referred to as a “self-forming barrier” (SFB) layer because, during annealing, it forms the Mn-Si-Oxide barrier 826.

FIG. 8F illustrates chemical-mechanical planarization (CMP) of the metal (e.g., copper or copper alloy) that overfills cavities 819 and 820. As illustrated, the continuous stack-integrated metallic optical elements 851 and 852. Are fully formed within the dielectric layers, including the Mn-Si-Oxide barrier 826 and the stacked resonator dielectric layer 817. As previously described, the base metallic optical elements 723 and 724 include different metallic barrier layers 721 and 722, such as tantalum (Ta), that electrically connect the continuous stack-integrated metallic optical elements 851 and 852 to the via layer 702. Additionally, the metallic barrier layers 721 and 722 (e.g., tantalum) provide mechanical stability to the continuous stack-integrated metallic optical elements 851 and 852 by providing good adhesion or other mechanical connection to the resonator etch-stop layer 715 (e.g., NBLoK® or BLOk® material) and/or to the top dielectric layer(s) of the via layer 702.

In some embodiments, not illustrated, the process may include forming additional dielectric passivation layers on top. The additional dielectric passivation layers may be deposited during the passivation of bond pads or other elements of the metasurface device, and are ancillary to the presently described systems and methods. If applied, these additional dielectric passivation layer(s) may be etched back to expose the continuous stack-integrated metallic optical elements 851 and 852.

As described herein, any number of additional stacked metallic optical elements 823 and 824 may be formed on top of the base metallic optical elements 723 and 724 using sequential single-damascene processes with manganese-based SFB layers. The aspect ratio of the base metallic optical elements 723 and 724, each sequentially formed, stacked optical elements, and the number of stacked optical elements may be selected to achieve continuous stack-integrated metallic optical elements with target aspect ratios, inter-element spacings, length and width dimensions, shapes, and/or diameters.

FIG. 8G illustrates a gap 825 (e.g., a cavity or channel) between the fully exposed first stack-integrated metallic optical element 851 and the second stack-integrated metallic optical element 852 after one or more etching processes (e.g., a BOE etching process). In the illustrated example, the first stack-integrated metallic optical element 851 is a continuous, double-stacked metallic optical element. As described in conjunction with FIGS. 7A-8F, the continuous stack-integrated metallic optical element 851 originally included a base metallic optical element 723 formed via a first single-damascene process with a tantalum barrier and a stacked metallic optical element 823 formed via a second single-damascene process with a manganese-based SFB layer 821.

Similarly, the second stack-integrated metallic optical element 852 is a double-stacked metallic optical element that originally includes a base metallic optical element 724 and a stacked metallic optical element 824. Sequential single-damascene processes with different barrier layers are used to form the base metallic optical element 724 and the stacked metallic optical element 824.

The etching process(es), as illustrated, is/are used to remove the stacked dielectric cap layer 807, the stacked resonator dielectric layer 817, and the base resonator dielectric layer 717. Notably, the etching process removes the metallic barriers 721 and 722 from the sidewalls of the base metallic optical elements 723 and 724 while leaving patches 721A and 722A unetched. The patches 721A and 722A may be shaped similarly to that of the base of the base metallic optical elements 723 and 724 (e.g., square, rectangular, circle, oval, conic slice, trapezoidal, rectangular, elongated strip, etc.).

The patches 721A and 722A of the metallic barriers 721 and 722 remain in place between the metallic optical elements 723 and 724 and the dielectric layers of the via layer 702 to prevent diffusion of the copper (or other metal(s)) of the base metallic optical elements 723 and 724. The patches 721A and 722A of the metallic barriers 721 and 722 also provide a conductive connection between the metallic vias (e.g., metallic via 713 of FIG. 7G) of the via layer 702 and the base metallic optical elements 723 and 724.

Moreover, the patches 721A and 722A of the metallic barrier 721 and 722 may, as described herein, be tantalum (Ta) or a tantalum alloy. The patches 721A and 722A of tantalum mechanically bond the stack-integrated metallic optical element 851 and 852 to the resonator etch-stop layer 715 and/or the top layer(s) of the via layer 702. In some embodiments, the resonator etch-stop layer 715 may be omitted, in which case the patches 721A and 722A (e.g., tantalum) mechanically bond the stack-integrated metallic optical element 851 and 852 to the top dielectric layer or top dielectric layers of the via layer 702 (e.g., dielectric cap layer 707 and/or dielectric mid-layer 705 in FIG. 7D).

The etching process also removes the Mn-Si-Oxide barrier 826 from the sidewalls of the stacked metallic optical elements. In some embodiments, a single etching solution is used to remove all the unwanted material. In other embodiments, sequential etching is performed with different buffered oxide etching solutions. In some instances and/or use-cases, the Mn-Si-Oxide barrier 826 may be sufficiently transparent and/or reflective to operational wavelengths so as not to require removal.

According to various embodiments, and as described herein, the gap 825 may be filled with a tunable dielectric material, such as liquid crystal. In the illustrated example, the stack-integrated metallic optical elements 851 and 852 have a high aspect ratio of approximately 7.5:1. In the illustrated example, the base metallic optical elements 723 and 724 and the stacked metallic optical elements 823 and 824 are approximately the same size and form a continuous taper (see, e.g., FIG. 8D). In other embodiments, they may be different sizes and/or form a stepped taper.

In some examples, the base metallic optical elements 723 and 724 may have an aspect ratio of 3:1, while the stacked metallic optical elements 823 and 824 may have an aspect ratio of only 2:1. In such an embodiment, the resulting stack-integrated metallic optical elements 851 and 852 would have a relatively high aspect ratio of approximately 5:1. A one-dimensional array of elongated stack-integrated metallic optical elements 851 and 852 may be used to form a metasurface that is steerable in one direction. A two-dimensional array of stack-integrated metallic optical elements 851 and 852 (e.g., rectangular, square, polygonal, oval, or circular pillars) may be used to form a metasurface that is steerable in multiple directions.

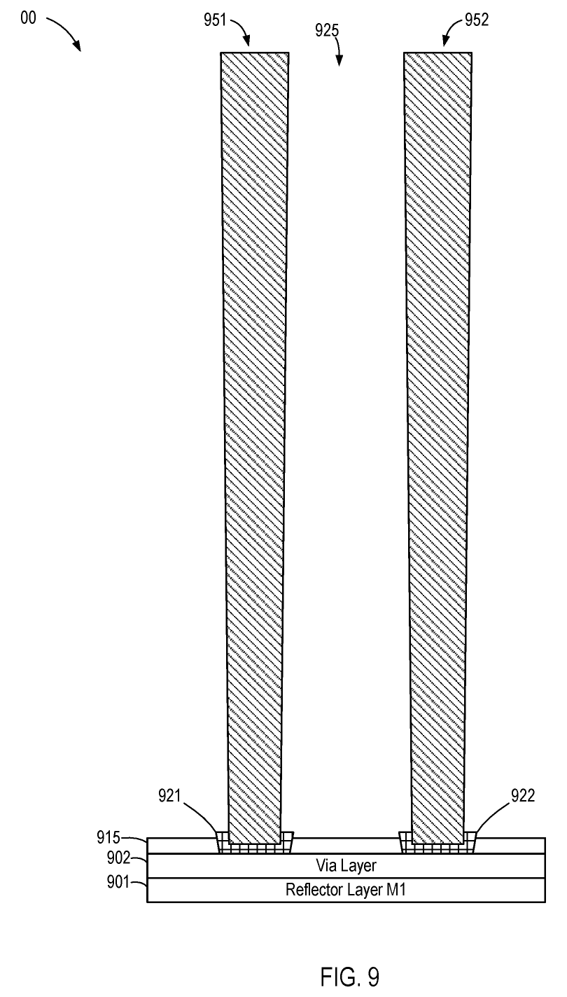

FIG. 9 illustrates an example of a high-aspect-ratio optical resonator 900 formed with stack-integrated metallic optical elements 951 and 952, according to one embodiment. In the illustrated embodiment, the use of a Mn-based SFB for the first stacked optical elements (and at least one additional stacked optical element) results in the seamless formation of each of the stack-integrated metallic optical elements 951 and 952. The first stack-integrated metallic optical element 951 is physically isolated from and conductively connected to the via layer 902 by a patch 921 of the metallic barrier (similar to the manganese-based SFB layer 821 of FIG. 8A).

As previously described, the patch 921 of the metallic barrier may comprise tantalum (Ta). The patch 921 may mechanically bond the first stack-integrated metallic optical element 951 to the via layer 902. The patch 921 of tantalum may also be mechanically bonded to and mechanically supported by the resonator etch-stop layer 915 (similar to the resonator etch-stop layer 715 of FIG. 8A). In various embodiments, the etch-stop layer 915 may be, for example, an etch-resistant NBLoK® or BLOk® material available from Applied Sciences, Inc.

The first stack-integrated optical element 951 includes a base metallic optical element, a first stacked metallic optical element, and a second stacked metallic optical element. However, the Mn-based SFB results in a seamless bonding of the base and stacked metallic optical elements. In the illustrated example, the tapered walls of the base and the stacked metallic optical elements are aligned so that the first stack-integrated optical element 951 is formed as a continuous, high-aspect-ratio metallic optical element.

The second stack-integrated metallic optical element 952 includes a base metallic optical element, a first stacked metallic optical element, and a second stacked metallic optical element. Again, using the Mn-based SFB to form the stacked metallic optical elements results in the seamless stack-integrated metallic optical element 952. The second stack-integrated metallic optical element 952 is physically isolated from and conductively connected to the via layer 902 by a patch 922 of the metallic barrier (722 of FIG. 8A). Again, the patch 922 of the metallic barrier may comprise tantalum (Ta) and may mechanically bond the first stack-integrated metallic optical element 951 to the via layer 902 and/or the resonator etch-stop layer 915. The patches 921 and 922 of the metallic barrier are not necessarily drawn to scale. The via layer 902 and the underlying reflector layer 901 may be, for example, manufactured as described in conjunction with the via layer 702 and reflector layer 701 in FIGS. 7A-8G.

A gap 925 is formed between the stack-integrated metallic optical elements 951 and 952 that can be, for example, filled with liquid crystal or another tunable dielectric material. According to various embodiments, each of the stack-integrated metallic optical elements 951 and 952 of the high-aspect-ratio optical resonator 900 may have an aspect ratio of greater than 4:1 (e.g., 9.5:1), where the height of each stack-integrated metallic optical element 951 and 952 is at least four times a maximum, minimum, or average width thereof.

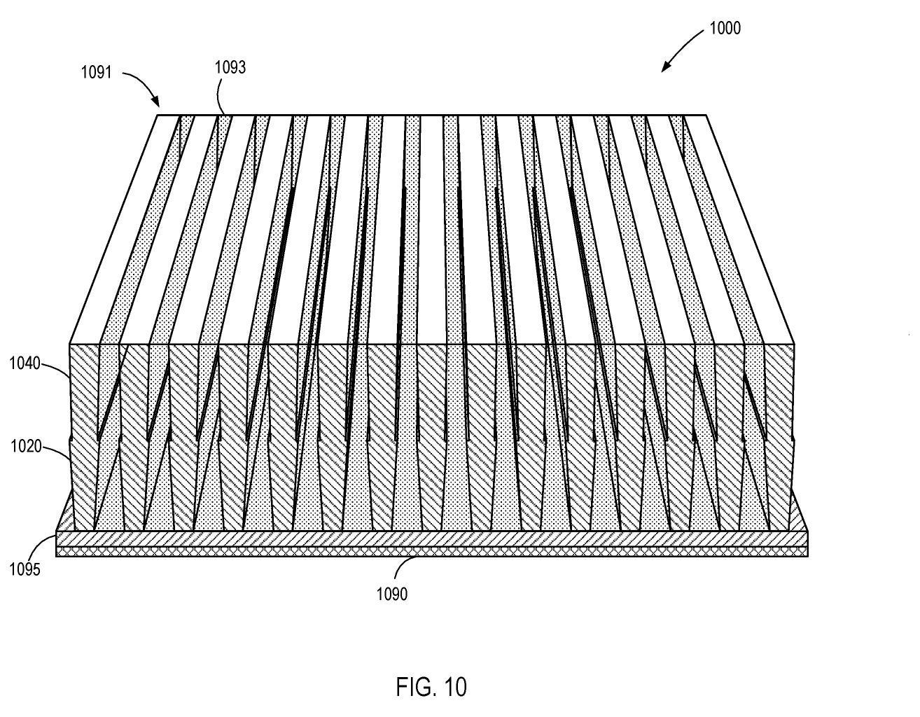

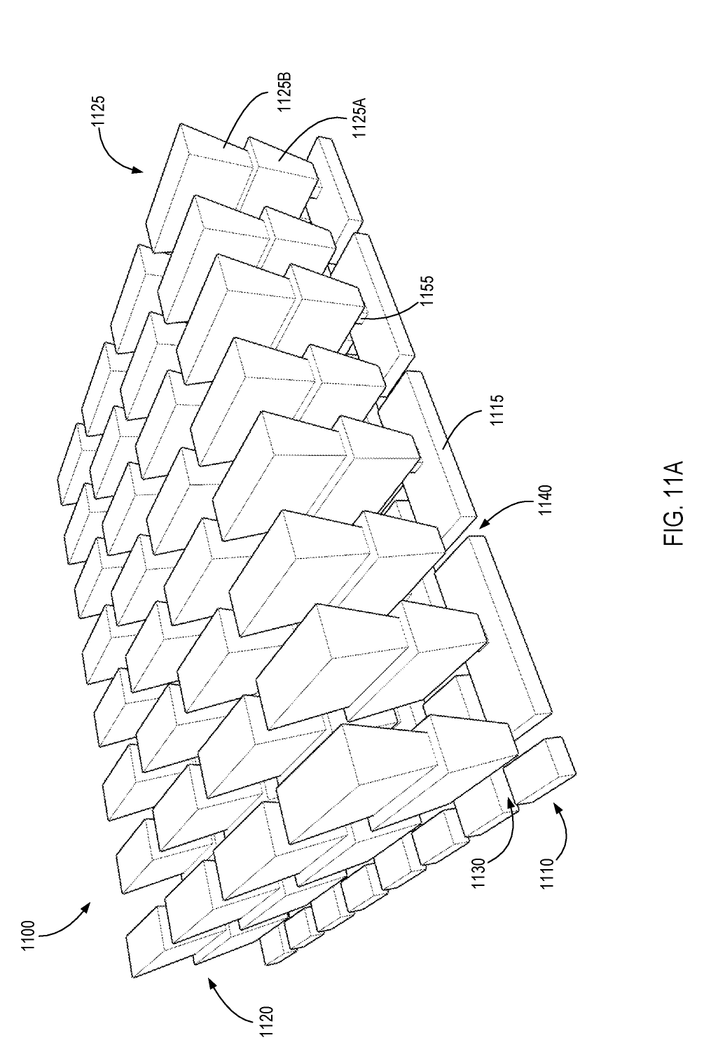

FIG. 10 illustrates a perspective view of a simplified block diagram of a tunable metasurface 1000 that is steerable in one dimension, with double-stacked, stack-integrated metallic optical elements 1091 forming high-aspect-ratio optical resonators, according to one embodiment. The tunable metasurface 1000 can, for example, be used as part of a solid-state optical transmitter or receiver subsystem, or as part of a transceiver system, of a software-defined lidar device. As illustrated, the tunable metasurface 1000 includes an optically reflective substrate 1090 and a dielectric layer 1095 (e.g., a via layer with vias that connect portions of the optically reflective substrate 1090 to individual double-stacked metallic optical elements 1091).

The stack-integrated metallic optical elements 1091 form elongated rails that may, for example, be arranged at sub-wavelength intervals on the optically reflective substrate 1090. For example, each stack-integrated metallic optical element 1091 may form elongated rectangular rails (tapered, non-tapered, tiered, or uniformly tapered). As illustrated, each stack-integrated metallic optical element 1091 comprises multiple metallic optical elements, including a base metallic optical element 1020 formed via a first damascene process (e.g., a single-damascene process or as part of a dual-damascene process with an earlier layer) and a stacked metallic optical element 1040 formed via a subsequent single-damascene process.

As per the embodiments described in conjunction with FIGS. 8A-8F, the stacked metallic optical element 1040 may be formed using a manganese-based SFB layer. The manganese-based SFB layer is annealed during the single-damascene process to seamlessly or near-seamlessly join the stacked metallic optical element 1040 to the base metallic optical element 1020. The manufacturing approach that includes annealing the manganese-based SFB layer produces continuous, high-aspect-ratio, stack-integrated metallic optical elements that are seamless or nearly seamless.

Liquid crystal or another refractive index tunable dielectric material 1093 may be positioned between the stack-integrated metallic optical elements 1091, as described in the context of the various metasurfaces described in the references incorporated herein by reference. The metasurface 1000 can be used for beam steering in one direction, so that incident optical radiation can be selectively steered to various angles (e.g., as scan lines steered along a single axis).

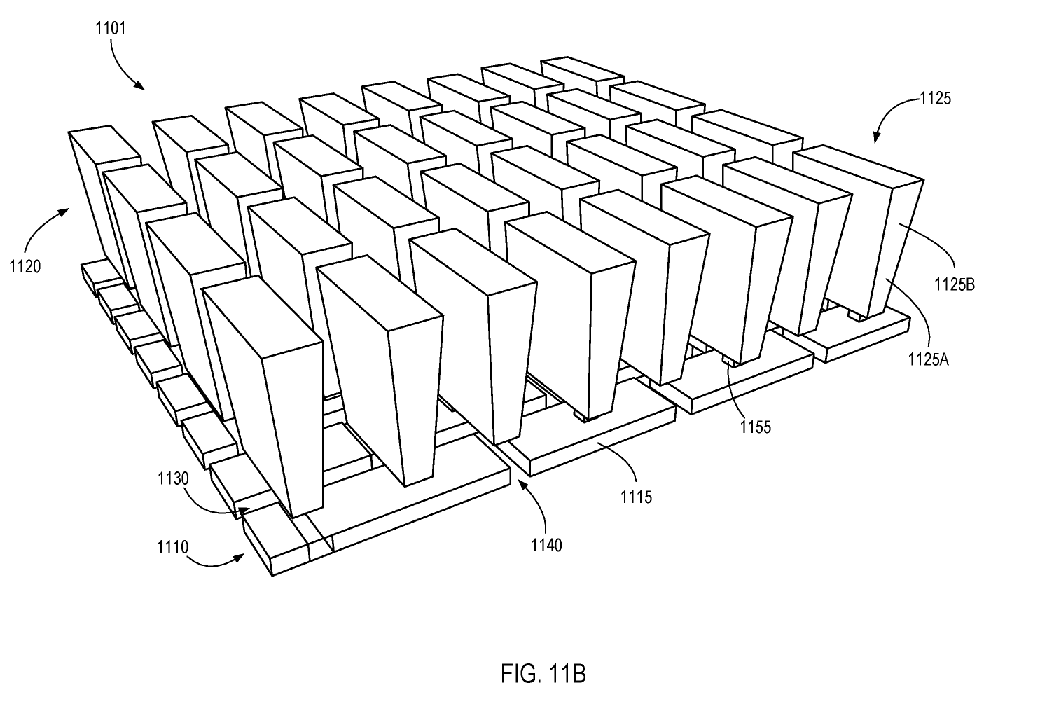

FIG. 11A illustrates a perspective view of a simplified block diagram of steerable metasurface 1100, with stack-integrated metallic optical elements 1125 forming high-aspect-ratio optical resonators, according to one embodiment. As illustrated, the resonator layer 1120 includes a two-dimensional array of metallic optical pillars or blocks (referred to more generally as optical resonator structures), each comprising a metallic optical element 1125. The metallic optical elements 1125 are arranged in parallel rows. Each metallic optical element 1125 metallic optical element 1125 comprises a base metallic optical element 1125A and a stacked metallic optical element 1125B. The base metallic optical elements 1125A and the stacked metallic optical element 1125B may be formed, for example, using the sequential single-damascene processes described according to any of the various embodiments detailed herein, including the embodiments described in conjunction with FIGS. 8A-G with an annealed manganese-based SFB layer. In the illustrated example, the base metallic optical element 1125A and the stacked metallic optical element 1125B form a continuous structure in the vertical direction, even though their tapered shapes and sizes result in a stepped profile along the perimeter. As previously described, the dimensions of the base metallic optical elements 1125A and the stacked metallic optical elements 1125B may be selected such that the profiles of the perimeter walls of each stack-integrated metallic optical element 1125 are vertical, near vertical, or form a continuous taper.

Each stack-integrated metallic optical element 1125 in the resonator layer 1120 extends vertically relative to an underlying substrate layer (not shown). The stack-integrated metallic optical elements 1125 in each row may be spaced from one another by less than the smallest wavelength in an operational bandwidth in one or both directions, depending on the target steerability. The width (W) of each stack-integrated metallic optical element 1125 along each row may be less than one-half of the smallest wavelength of the operational bandwidth. The length (L) of each stack-integrated metallic optical element 1125 in a direction perpendicular to each row (e.g., along the columns) may be less than the smallest wavelength of the operational bandwidth.

As described herein, optical resonators are formed by adjacent stack-integrated metallic optical elements 1125 and the gaps therebetween. A tunable dielectric material may be deposited within the gaps in the resonator layer 1120, filling the spaces between the stack-integrated metallic optical elements 1125 in all directions. Examples of suitable tunable dielectric materials with tunable refractive indices include liquid crystals, electro-optic polymers, electro-optic crystals, chalcogenide glasses, and/or various semiconductor materials.

In alternative embodiments, the stack-integrated metallic optical elements 1125 in each row may be spaced from one another by more than a wavelength within the operational bandwidth (e.g., by a factor of 10 times the largest wavelength in the operational bandwidth). Similarly, in some embodiments, the width (W) of each stack-integrated metallic optical element 1125 along each row may be more than one-half of the smallest wavelength, and the length (L) of each stack-integrated metallic optical element 1125 in a direction perpendicular to each row (e.g., along the columns) may be many times larger than the largest wavelength of the operational bandwidth.

The reflective layer 1110 includes a two-dimensional array of elongated rectangular reflector patches 1115 extending lengthwise along parallel rows. As illustrated, the reflector patches 1115 extend lengthwise, perpendicular to the lengthwise direction of the stack-integrated metallic optical elements 1125. An electrical isolation gap 1130 separates reflector patches 1115 in adjacent rows. An off-resonance gap 1140 separates adjacent reflector patches 1115 in the same row. The direction of the electrical isolation gap 1130 is off-resonance with respect to the incident electric field, so there is little or no resonant coupling. The off-resonance gap 1140 between adjacent reflector patches 1115 is perpendicular to the incident electrical field. Accordingly, the off-resonance gap 1140 is selected to minimize or avoid any possible resonance between reflector patches 1115 in the same row across a range of optical radiation wavelengths. The off-resonance gap 1140 may be different in size from the electrical isolation gap 1130.

A dielectric via layer may be positioned between the reflective layer 1110 and the resonator layer 1120. The dielectric via layer may, for example, be formed as described in conjunction with FIGS. 7A-7G. Each stack-integrated metallic optical element 1125 may be electrically connected to one underlying reflector patch 1115 by a conductor via 1155 within the dielectric via layer. The dielectric of the dielectric via layer has been removed from the figure for clarity to show the positioning of the conductor vias 1155.

FIG. 11B illustrates another perspective view of a simplified block diagram of a metasurface 1101 with stack-integrated metallic optical elements that form high-aspect-ratio optical resonators, according to one embodiment. In FIG. In FIG. 11B, the tapered shapes of the first and second stack-integrated layers are selected to align and form smooth sidewalls rather than stepped features. Specifically, the top layer is selected to have a base size that corresponds to the top surface of the base layer. The other features are similar and described in conjunction with FIG. 11A above.

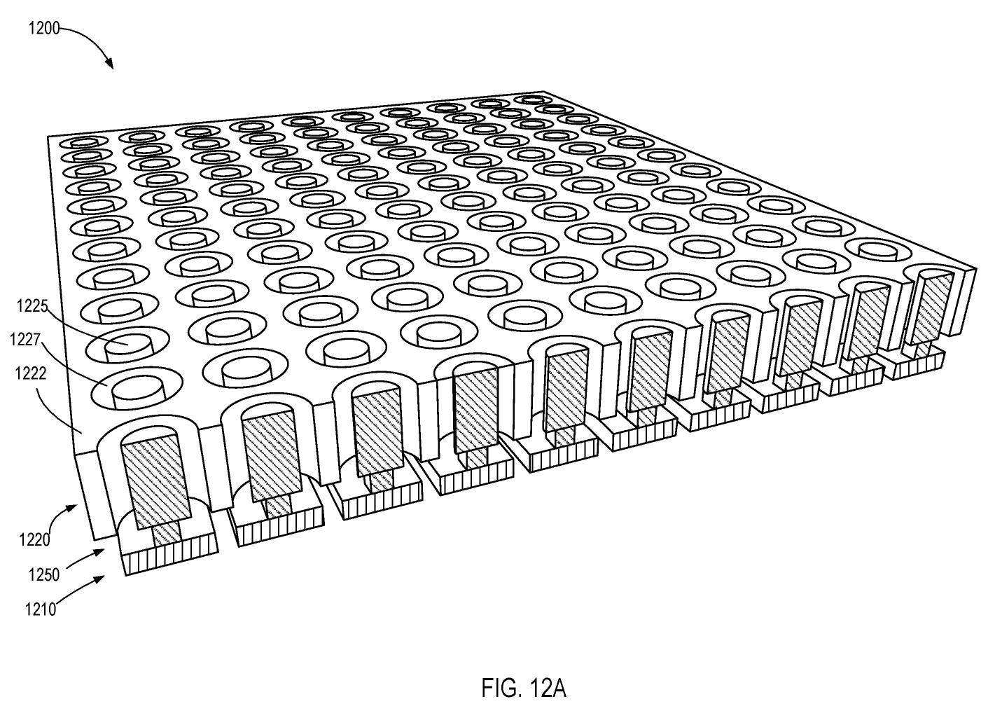

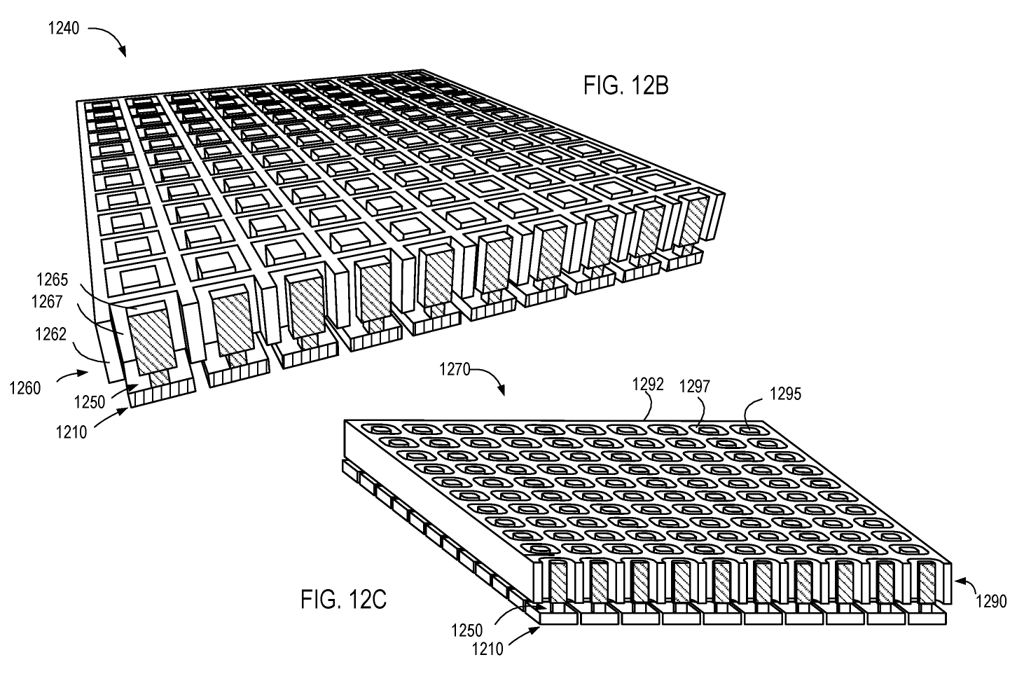

FIG. 12A presents a perspective view of a portion of an active-matrix tunable optical metasurface 1200, including an optical resonator layer 1220, a via layer 1250, and a reflective layer 1210. In some embodiments, the illustrated example may be considered a representative tile of a multi-tile array of ring-aperture resonators. The optical resonator layer 1220 includes a continuous metallic planar layer 1222 (e.g., a continuous conductive sheet) patterned with sub-wavelength-pitch circular apertures 1227. Within each aperture, a corresponding metallic pillar 1225 is centered and electrically isolated from the surrounding planar layer 1222, forming a ring-shaped aperture or annular gap. As described herein, the ring-shaped apertures or annular gaps may be filled with a tunable dielectric material (e.g., liquid crystal); however, the tunable dielectric material is omitted in FIG. 12A for clarity. The center-to-center pitch between adjacent apertures is less than one-half of the operational wavelength to provide full tunability. In some embodiments, larger pitches may be used in one or both directions to provide less modulation control in one or both directions.

As illustrated, each pillar 1225 extends downward through the optical resonator layer 1220 and terminates in a corresponding conductive via within via layer 1250 that bridges to an underlying active-matrix drive stack, as subsequently illustrated and otherwise described herein. In the simplified block diagram of FIG. 12A, the vias in the via layer 1250 appear as the rectangular features arranged in rows along the bottom of the drawing.

The optically reflective layer 1210 is depicted as a plurality of rectangular elements forming a nearly continuous layer. However, as described herein, an array of ring-aperture reflectors may be used instead. In various embodiments, the reflector layer reflects incident light back toward the resonator layer, so that, in some implementations, phase modulation occurs in a double pass, thereby doubling the available phase shift. The reflective metasurface also eliminates the need for a separate transparent substrate. In the illustrated example, the ring-aperture resonators are arranged in orthogonal rows and columns to enable M + N row- and column-addressing.

FIG. 12B illustrates a perspective view of an active-matrix tunable optical metasurface 1240 with ring-aperture resonators with square pillars 1265, according to one embodiment. The active-matrix tunable optical metasurface 1240 includes an optical resonator layer 1260, a via layer 1250, and a reflective layer 1210. The optical resonator layer 1260 includes a continuous metallic planar layer 1262 (e.g., a continuous conductive metal sheet or layer(s)) patterned with a sub-wavelength pitch of rectangular apertures 1267. Within each aperture, a corresponding metallic pillar 1265 is centered and electrically isolated from the surrounding planar layer 1262, forming rectangular ring-shaped apertures or rectangular annular gaps. The rectangular, ring-shaped apertures, or annular gaps, may be filled with a tunable dielectric material (e.g., a liquid crystal). The tunable dielectric material is omitted in FIG. 12B for clarity. In various embodiments, the pitch between adjacent apertures is less than one-half of the operational wavelength.

The optically reflective layer 1210 is depicted as a plurality of rectangular elements forming a nearly continuous layer. However, as described herein, an array of ring-aperture reflectors may be used, as described herein and within the U.S. Patent Applications previously incorporated by reference herein. In various embodiments, the reflector layer reflects incident light back toward the resonator layer, so that, in some implementations, phase modulation occurs in a double pass, doubling the available phase shift. In the illustrated example, the rectangular ring-aperture resonators are arranged in orthogonal rows and columns to enable M + N row- and column-addressing.

FIG. 12C illustrates a perspective view of an active-matrix tunable optical metasurface 1270 with ring-aperture resonators that have rounded-edge or rounded-corner rectangular pillars 1295, according to one embodiment. The active-matrix tunable optical metasurface 1270 includes an optical resonator layer 1290, a via layer 1250, and a reflective layer 1210. The optical resonator layer 1290 includes a continuous metallic planar layer 1292 patterned with a sub-wavelength pitch of rounded-edge rectangular apertures 1297 (e.g., with rounded corners). A metallic pillar 1295 is centered within each aperture and electrically isolated from the surrounding planar layer 1292. The rounded-edge rectangular pillars 1295 within the rounded-edge rectangular apertures 1297 form rounded-edge rectangular ring-shaped apertures or annular gaps. The annular gaps may be filled with a tunable dielectric material (e.g., liquid crystal), which is omitted for clarity.

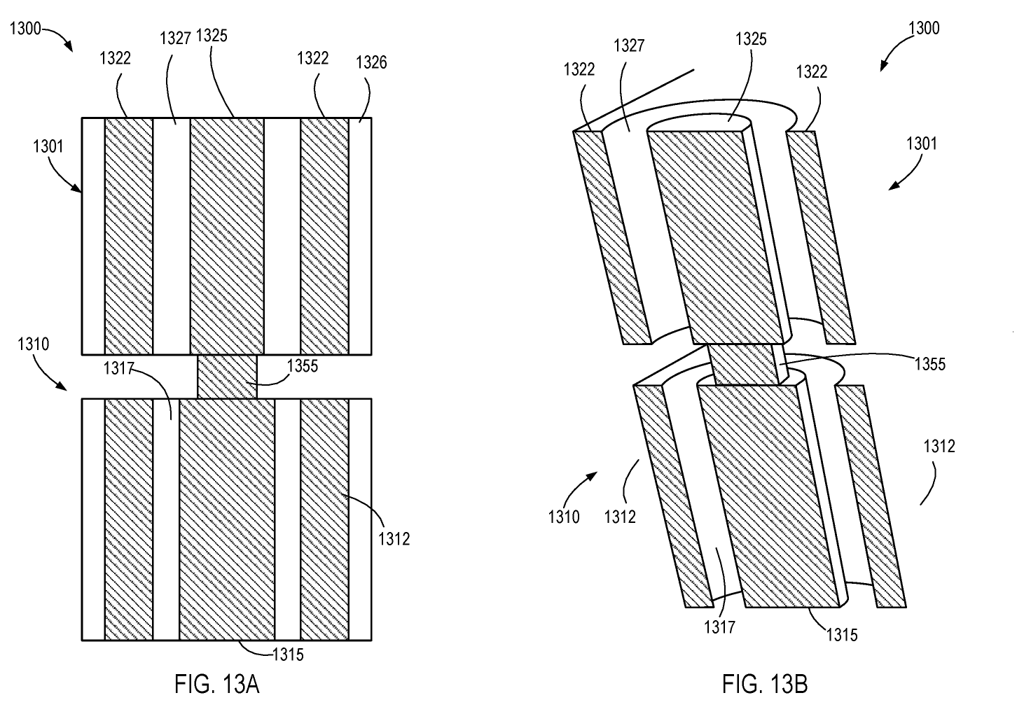

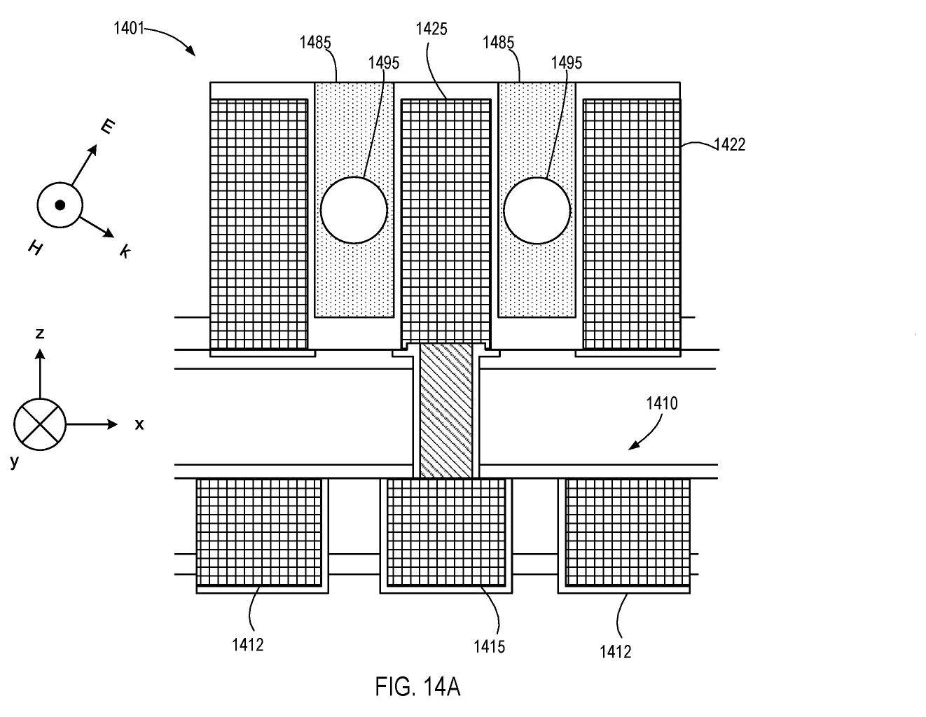

FIG. 13A illustrates a cross-sectional view of a resonator unit cell 1300, including a ring-aperture resonator 1301 and a ring-aperture reflector 1310, according to one embodiment. As illustrated, the ring-aperture resonator 1301 includes a metallic pillar 1325 within an aperture formed in a continuous metallic planar layer 1322. The visualization of the resonator unit cell 1300 shows a passivation coating 1326 applied to the exposed surfaces of the metallic pillar 1325 and the continuous metallic planar layer 1322. In a multicell array of resonator unit cells, the illustrated cross sections of the continuous metallic planar layer 1322 may be shared by adjacent resonator unit cells 1300. A tunable dielectric material, such as a liquid crystal, is deposited within the ring-shaped aperture or annular gap 1327 of each ring-aperture resonator.

As illustrated, the resonator unit cell 1300 includes a ring-aperture reflector 1310 formed in an aperture in a reflective planar layer 1312. The ring-aperture reflector 1310 includes a reflective pillar 1315 centered in the aperture, forming a ring-shaped aperture 1317 between the reflective pillar 1315 and the reflective planar layer. A dielectric material (e.g., silicon nitride, silicon dioxide, or another dielectric material) may be positioned within the ring-shaped aperture 1317 to electrically isolate the reflective pillar 1315 from the reflective planar layer 1312. A conductive via 1355 within a via layer electrically connects the metallic pillar 1325 to the reflective pillar 1315.

FIG. 13B illustrates a perspective cut-away view of the resonator unit cell 1300, including the ring-aperture resonator 1301 and the ring-aperture reflector 1310. The simplified block diagram shows the metallic pillar 1325 connected to the reflective pillar 1315 via the conductive via 1355. The ring-shaped aperture 1317 of the ring-aperture reflector 1310 may be filled with an electrically isolating dielectric. In contrast, the ring-shaped aperture or annular gap 1327 of the ring-aperture resonator 1301 is filled with a tunable dielectric.

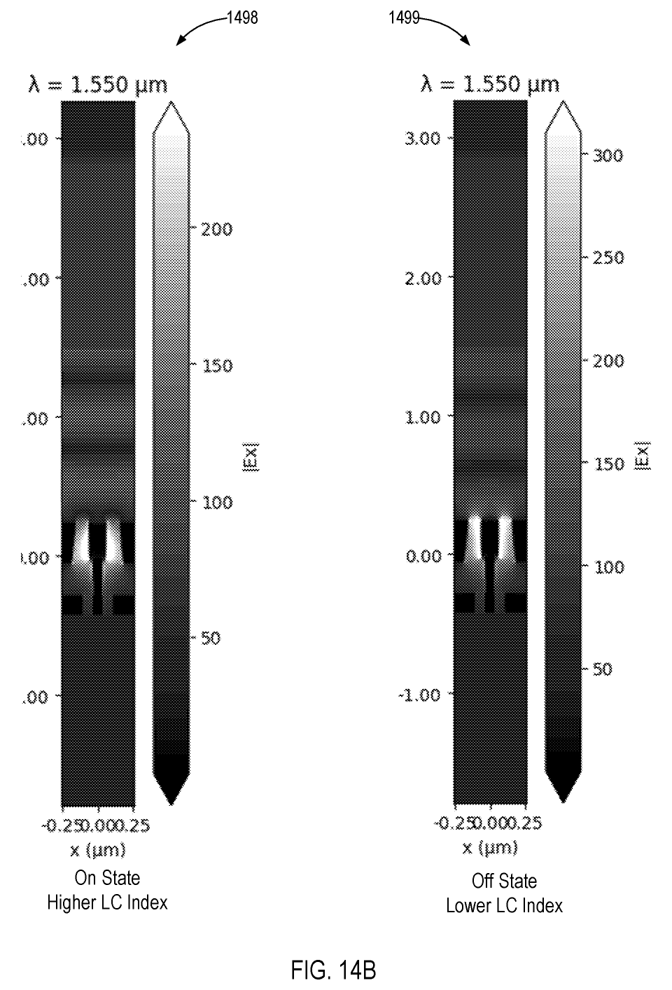

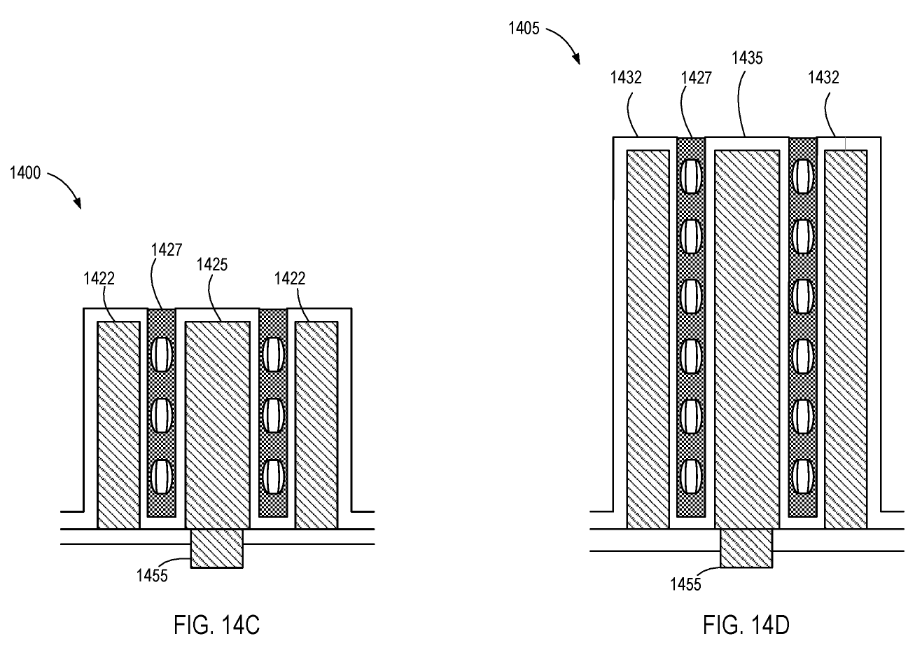

FIG. 14A illustrates an example cross-sectional diagram of a ring-shaped optical field 1495 within the tunable dielectric material 1485 in an annular gap of a ring-aperture resonator 1401 of a tunable optical metasurface, according to one embodiment. The thickness of the continuous metallic planar layer 1422 and the height of the metallic pillar 1425 are selected to achieve first-order resonance with a single magnetic-field antinode 1495. For example, the aspect height-to-width aspect ratio of the ring-aperture resonator exhibiting first-order resonance may be between 0.5:1 and 2:1. In other embodiments, second-order or higher-order resonances may be achieved with metallic pillars of increased height (e.g., with higher aspect ratios). A controller can drive the metallic pillar 1425 to a target voltage, creating a voltage differential between the metallic pillar 1425 and the continuous metallic planar layer 1422. The refractive index of the tunable dielectric material 1485 can be adjusted to a target value based on the applied voltage difference.

As previously described, the optically reflective layer 1410 may, in some embodiments, comprise a reflective planar layer 1412 with a ring-aperture reflector formed therein that is off-resonance with respect to the ring-aperture resonator 1401. The ring-aperture reflector comprises a reflective pillar 1415 within an aperture in the reflective planar layer 1412. The diameter of the reflective pillar 1415 and/or the dimensions of the aperture in the reflective planar layer 1412 are selected to be off-resonance with respect to the ring-aperture resonator 1401.

FIG. 14B illustrates simulations of the optical fields of a ring-aperture resonator in an “on state” and in an “off state,” according to one embodiment. The simulated cross-sectional image shows the magnitude of the electric field, |Ex|, at a wavelength of 1.550 µm. The left image 1498 illustrates the on state with the liquid‑crystal material in the annular gap electrically driven to a higher refractive index (e.g., n ≈ 1.908). The field profile exhibits fundamental resonance, with the intensity antinode pulled slightly downward (toward negative z) relative to the intensity antinode in the off state, as shown in the right image 1499. The right image 1499 shows the off state with no applied voltage, resulting in a lower refractive index (e.g., n ≈ 1.546). In the off state, the same fundamental resonance appears, but the field maximum is located slightly higher within the cavity.

In both images 1498 and 1499, the grayscale bar indicates normalized |Ex| amplitude. The horizontal axis shows an example annular gap width of 0.5 µm between a metallic pillar and a metallic planar layer in a ring-aperture resonator. The vertical axis corresponds to the height of an annular gap between the metallic pillar and a metallic planar layer, extending from approximately z = ‑1.5 µm (e.g., at the reflective backplane) to z = 3 µm (e.g., the top of the resonator layer). The heights of the metallic pillar and planar layer may be selected to achieve fundamental, second-order, or higher-order resonance, as specified by operational requirements, including, in many embodiments but without limitation, heights between approximately 100 nanometers and 400 nanometers.

FIG. 14C illustrates a cross-sectional diagram of a ring-shaped optical field with three anti-nodes within the tunable dielectric material 1427 in an annular gap of a ring-aperture resonator 1400, according to one embodiment. As illustrated, a tunable dielectric material 1427 is positioned within the annular gap of the ring aperture resonator 1400. In the illustrated example, the height of the metallic pillar 1425 and the continuous metallic planar layer 1422 are selected to achieve third-order resonance with three magnetic-field antinodes. The ratio of the height to the width of the metallic optical pillar 1425 may, for example, be approximately 4:1, and the annular gap may have a subwavelength width (e.g., less than one-half of a smallest wavelength within an operational bandwidth). Inter-element on-center spacing of adjacent ring aperture resonators 1400 may also be subwavelength (e.g., less than one-half of an operational wavelength).

In some embodiments, the diameter of the metallic optical pillar 1425 may be between approximately 50 nanometers and 300 nanometers. The height of each metallic optical pillar 1425 may be between approximately 300 nanometers and 800 nanometers. Again, the dimensions and annular gap width may be selected based on the device's operating wavelengths. As previously described, a controller can drive the metallic optical pillar 1425 to a target voltage (e.g., using conductive via 1455), creating a voltage differential across the annular gap of the ring aperture resonator 1400. The refractive index of the tunable dielectric material 1427 can be adjusted to a target value by varying the applied voltage difference.

FIG. 14D illustrates a cross-sectional diagram of a ring-shaped optical field with six anti-nodes within the tunable dielectric material 1427 in an annular gap of a stack-integrated ring-aperture resonator 1405 with a higher aspect ratio, according to one embodiment. In the illustrated example, the height of the metallic optical pillar 1435 and the continuous metallic planar layer 1432 are selected to achieve sixth-order resonance with six magnetic-field antinodes within the high-aspect-ratio annular gap. The height-to-width ratio of the metallic optical pillar 1435 for the sixth-order resonance may, for example, be between approximately 7:1 and 8:1.

As described in conjunction with FIGS. 14A-14D, a ring-aperture resonator may be configured to have any target height-to-width aspect ratio to achieve a target resonance (e.g., first-order resonance, second-order resonance, third-order resonance, etc.), including aspect ratios between approximately 0.5:1 and 4:1 in many useful embodiments.

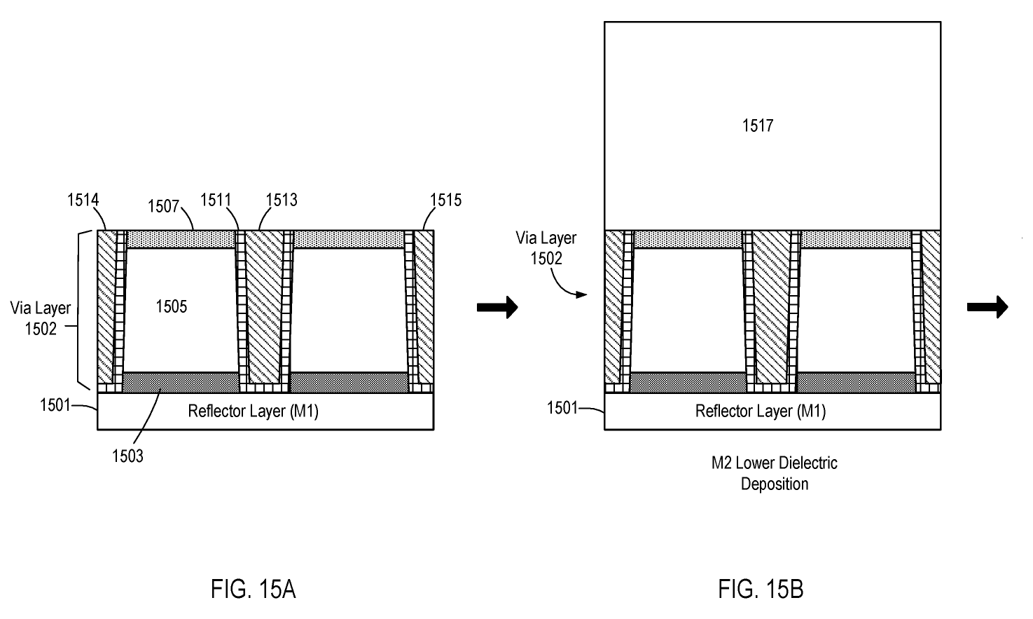

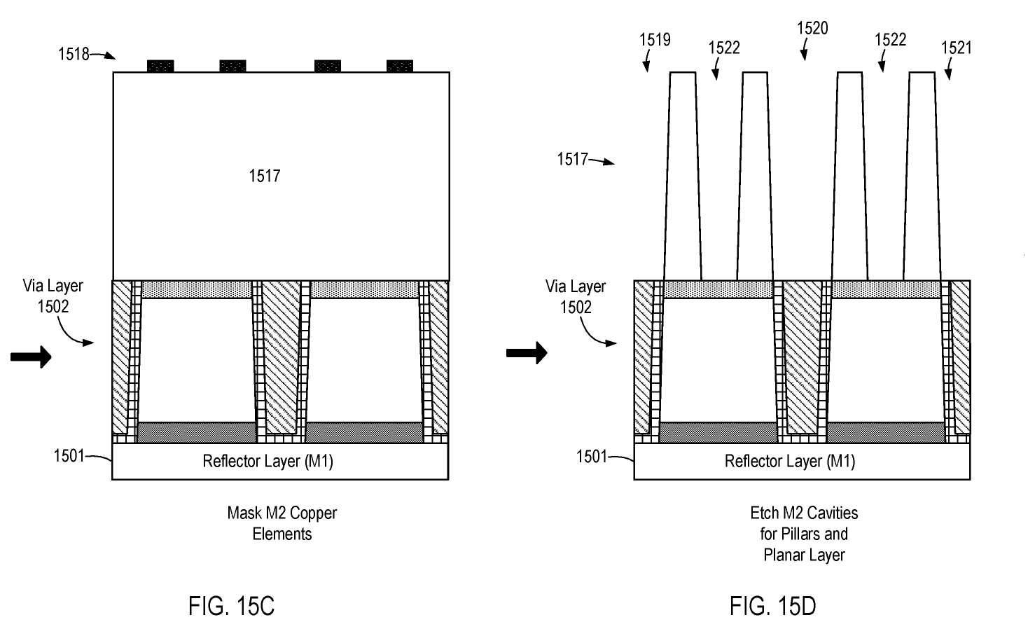

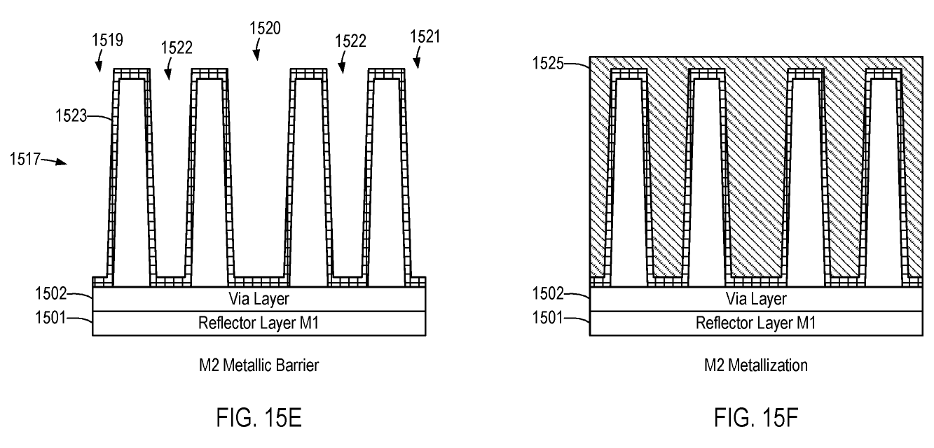

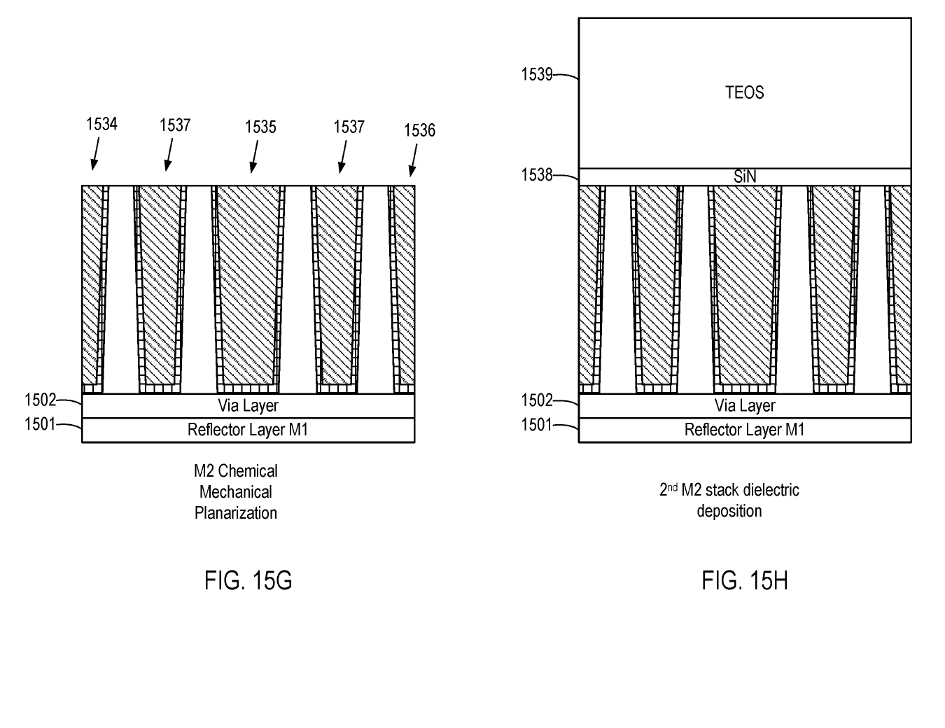

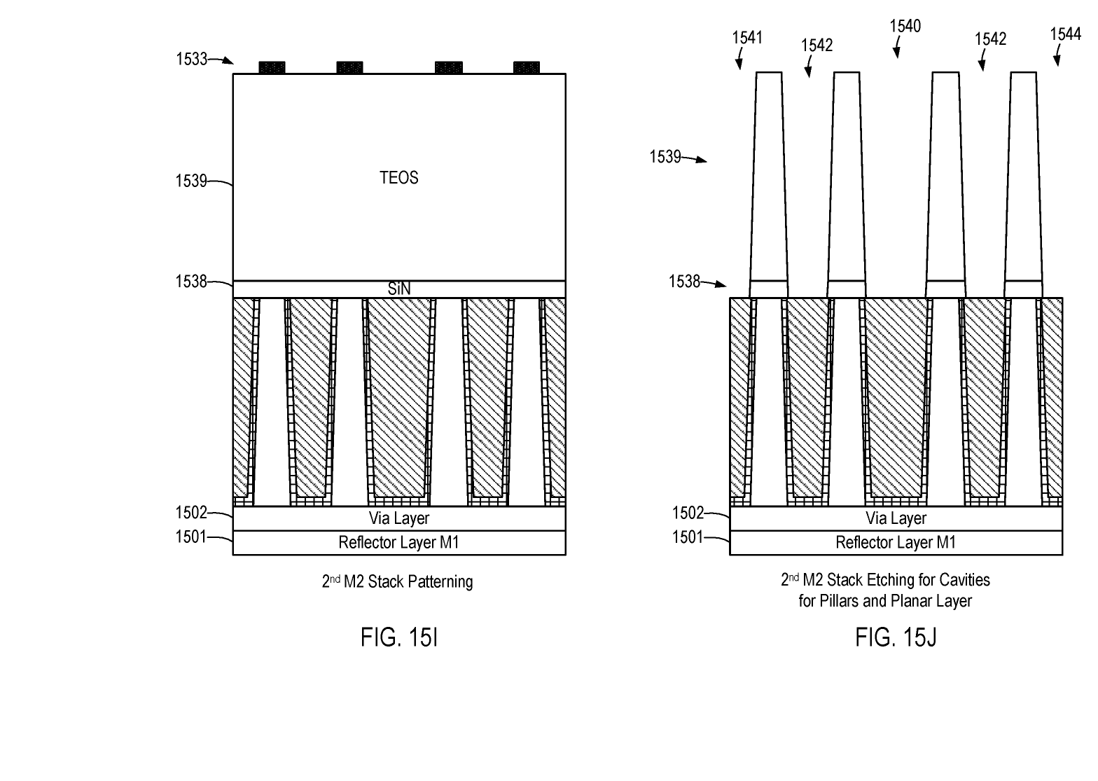

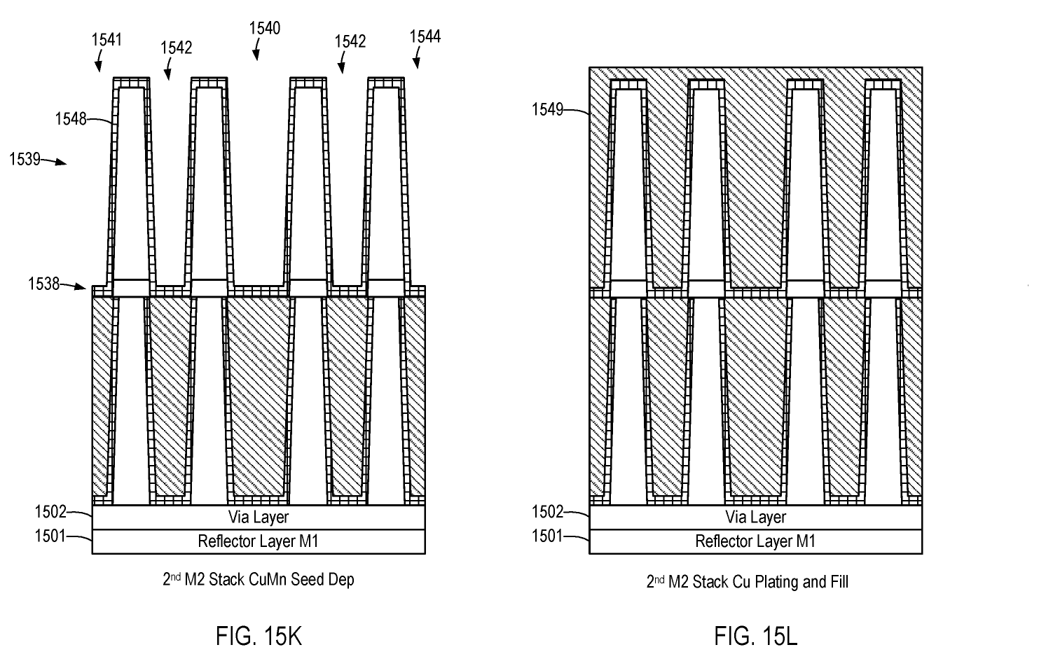

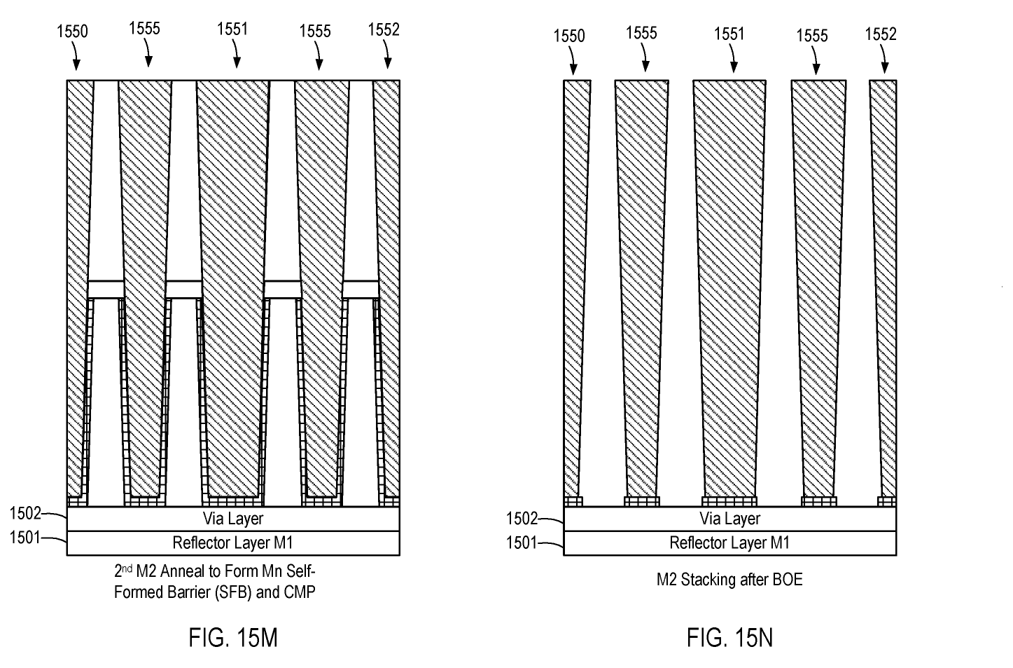

FIGS. 15A-G illustrate block diagrams of a single-damascene process to form a base metallic optical element of a stack-integrated ring-aperture optical resonator, according to one embodiment.

FIGS. 15H-M illustrate block diagrams of a single-damascene process to form a stacked ring-aperture metallic optical element using a self-forming barrier, according to one embodiment.

FIG. 15N illustrates a high-aspect-ratio ring-aperture optical resonator comprising stack-integrated metallic optical elements fabricated with a self-forming barrier, according to one embodiment.

FIG. 15A illustrates a portion of a metasurface device at a stage in which an optically reflective layer 1501 (reflector layer (M1)) has already been formed, and a via layer 1502 has been formed above the reflector layer 1501 to provide conductive connections from the reflector layer (M1) up to subsequently formed M2 (resonator-layer) copper elements.

In the illustrated embodiment, the via layer 1502 includes a dielectric etch-stop layer 1503, a dielectric mid-layer 1505, and an etch-resistant dielectric cap layer 1507. The dielectric etch-stop layer 1503 may comprise, for example, silicon nitride, and the dielectric mid-layer 1505 may comprise, for example, tetraethyl orthosilicate (TEOS) or another dielectric material selected to be compatible with the subsequent etch processes used to form M2 cavities (e.g., buffered oxide etchants). The dielectric cap layer 1507 may be selected to be resistant to the subsequent resonator-layer etch process used to form the M2 cavities, thereby protecting the via layer 1502 and maintaining well-defined cavity sidewalls in later steps (e.g., an etch-resistant NBLoK®/BLOk® material, silicon carbide, alumina, silicon nitride, nitrogen-doped silicon carbide, and/or layered combinations thereof).

The via layer 1502 further includes metallic vias 1513, 1514, and 1515 separated from the surrounding dielectric by a conductive barrier 1511. The conductive barrier 1511 may comprise, for example, tantalum (Ta), tantalum nitride (TaN), titanium nitride (TiN), and/or another suitable barrier/liner material. In the illustrated cross-section, the via 1513 is a via that will electrically connect to a subsequently formed center pillar of a first ring-aperture resonator in the M2 resonator layer. The vias 1514 and 1515 at the lateral edges of the figure are cut-off (partial) cross-sections of vias associated with adjacent ring-aperture resonators in the array (i.e., the illustrated structure may be part of a periodic, repeating layout, as described in detail herein.

FIG. 15B illustrates deposition of a resonator dielectric layer 1517 (labeled “M2 Lower Dielectric Deposition”) over the via layer 1502. The resonator dielectric layer 1517 is a dielectric material that will later be patterned and etched to form cavities/trenches corresponding to M2 copper features of a ring-aperture resonator (including at least a center-pillar cavity and one or more planar/plate cavities that collectively form a perforated planar layer). In various embodiments, the resonator dielectric layer 1517 may comprise TEOS or another dielectric selected with a compatible etch chemistry (e.g., buffered oxide etchants). The thickness of the resonator dielectric layer 1517 may be selected based on a desired height of the first M2 copper structures (e.g., the initial height of the ring-aperture resonator’s pillar and planar layer).

FIG. 15C illustrates a resonator mask layer 1518 patterned on top of the resonator dielectric layer 1517 to control subsequent etching of the resonator dielectric layer 1517. In various embodiments, the resonator mask layer 1518 may be implemented as a photoresist and/or a hardmask stack configured to define, in a single etch step (or a sequence of etch steps), cavities for the electrically conductive metallic pillars, including at least the center pillar that will be connected to via 1513. The etch step is also used to form cavities for the electrically conductive metallic planar/plate features that will ultimately form the planar layer portion of the ring-aperture resonator.

FIG. 15D illustrates etching of the second layer (M2) cavities through the resonator dielectric layer 1517 in accordance with the patterned resonator mask layer 1518, forming cavities 1519, 1520, and 1521 for the pillars and cavities 1522 for the continuous planar layer or plate (note: cavities 1522 are connected across the two-dimensional surface, but appear disconnected in the illustrated cross-sectional view of a the two-dimensional structure).

Specifically, in the illustrated cross-section, the etching forms a central cavity 1520 corresponding to an electrically conductive metallic pillar that will become the center pillar of a ring-aperture resonator, and cavities 1522 corresponding to portions of an electrically conductive metallic planar layer (or plate) that will surround the pillar. In the depicted cross-section, the planar-layer cavity appears as two separate cavities 1522 on either side of the pillar cavity 1520; however, in plan view (i.e., in the completed three-dimensional geometry), these etched regions correspond to a ring-shaped (annular) planar-layer cavity that defines an aperture around the center pillar cavity. Thus, when subsequently filled with metal (e.g., copper), the resulting M2 structures will include: a metallic pillar, and a perforated metallic planar layer surrounding the pillar, with an annular region between them that can be used to define the ring-aperture resonator gap to be filled with a tunable dielectric material.

FIG. 15D also illustrates partial cavities 1519 and 1521 corresponding to neighboring electrically conductive metallic pillars of adjacent ring-aperture resonators in the array. These neighboring pillar cavities 1519 and 1521 are only partially shown because the cross-section cuts through the edge portion of adjacent unit cells (consistent with FIG. 15A showing partial edge vias 1514 and 1515).

As in the analogous pillar-formation process described in conjunction with FIGS. 7A-D, the M2 etch is performed to stop on (or be controlled by) an etch-resistant layer (e.g., the dielectric cap layer 1507 and/or an additional resonator etch-stop layer, if present) so that the etch step does not destroy or undercut the underlying via-layer dielectrics. The etch may be performed as a multi-stage etch sequence (e.g., a first etch to a stop layer, followed by a controlled removal of the stop layer in selected regions) to expose the top of the center via 1513 for subsequent metallization/connection while avoiding damage to the via barrier 1511 and maintaining well-defined cavity sidewalls.

FIG. 15E illustrates a stage in which a metallic barrier layer 1523 is deposited on the exposed surfaces of a set of etched M2 cavities formed in the M2 resonator dielectric layer 1517 above the via layer 1502 and the reflector layer 1501 (reflector layer M1). In the illustrated example, the via layer 1502 is shown in a simplified (collapsed) format (e.g., without separately illustrating the etch-stop, mid-dielectric, and cap sublayers) to conserve drawing space and avoid obscuring the M2 feature formation. In various embodiments, however, the via layer 1502 may include an etch-stop layer, a dielectric mid-layer (e.g., TEOS), and an etch-resistant dielectric cap layer, as described herein.

In the illustrated cross-section, the etched cavities include a central pillar cavity 1520 that will be filled to form an electrically conductive metallic pillar for a first ring-aperture resonator (e.g., a center pillar that will ultimately be connected to an underlying via in via layer 1502). The illustrated cross-section also includes planar-layer (plate) cavity(ies) 1522 that will be filled to form portions of an electrically conductive metallic planar layer surrounding the pillar (in plan view, these cavities correspond to portions of a ring-aperture geometry; in cross-section, they appear as separate cavities on either side of the pillar cavity). The illustrated cross-section also shows partial pillar cavities 1519 and 1521 corresponding to neighboring ring-aperture resonators adjacent to the first ring-aperture resonator (shown only in part because the cross-section cuts through neighboring unit cells).

The metallic barrier layer 1523 is deposited on the sidewalls and bottom surfaces of the pillar and planar-layer cavities (e.g., cavities 1519, 1522, 1520, 1522, and 1521). The metallic barrier layer 1523 may, for example, operate to inhibit diffusion of subsequently deposited conductive metal (e.g., copper) into surrounding dielectric materials, enhance adhesion, and/or reduce corrosion or other degradation mechanisms at the dielectric/metal interface. In various embodiments, the metallic barrier layer 1523 comprises one or more of tantalum (Ta), tantalum nitride (TaN), titanium nitride (TiN), and/or other barrier/liner materials suitable for damascene metallization.

FIG. 15F illustrates an M2 metallization step in which a bulk metal 1525 is deposited to fill the barrier-lined cavities shown in FIG. 15E. In various embodiments, the bulk metal 1525 is copper or a copper-containing alloy deposited using a damascene metallization sequence that may include depositing a metal seed layer (e.g., copper seed), and electroplating (or otherwise filling) the cavities with copper to form void-free or substantially void-free metal features. The seed deposition may include, for example, sputtering and/or vapor deposition, depending on the targeted feature sizes and aspect ratios.

FIG. 15G illustrates the device after a chemical-mechanical planarization (CMP) step used to remove the bulk metal overburden (e.g., the portion of bulk metal 1525 deposited above the top surface of the resonator dielectric layer 1517). The CMP process may also be used to remove (or substantially remove) portions of the metallic barrier layer 1523 that are outside the etched cavities, thereby finalizing the formation of the base M2 conductive metal features embedded within the dielectric 1517.

In the illustrated cross-section, CMP leaves a set of planarized M2 metal features, including a metallic pillar 1535, corresponding to the center pillar of a first ring-aperture resonator (which, in the completed device, is electrically connected downward through via layer 1502). The illustrated example also includes metallic planar-layer portions 1537 disposed laterally on either side of the pillar 1535 (which, in plan view, correspond to portions of a continuous metallic planar layer perforated by apertures, and which surround the pillar to enable formation of a ring-aperture resonator). The neighboring metallic pillars 1534 and 1536 correspond to adjacent ring-aperture resonators in the periodic array (again shown in cross-section as partial neighboring structures). At this point in the process, a base metallic optical element is formed as a base ring aperture resonator.

FIG. 15H illustrates deposition of dielectric layers used to begin formation of a stack (i.e., a subsequent damascene “stack” above the base M2 features) to enable stack-integrated ring-aperture resonator structures that have an increased height/aspect ratio for the pillar and/or planar-layer portions. As shown, a stack dielectric cap or etch-stop layer 1538 is deposited on the planarized surface. In the illustrated example, the layer 1538 is labeled SiN, and may comprise silicon nitride (or another etch-resistant dielectric). The stack dielectric cap or etch-stop layer 1538 may be selected to resist one or more subsequent etch processes used to define cavities for the next stacked metal features, thereby protecting the already-formed base M2 structures and promoting well-defined cavity sidewalls in subsequent patterning steps.

A stack resonator dielectric layer 1539 is then deposited on top of the stack dielectric cap or etch-stop layer 1538. In the illustrated example, the layer 1539 is labeled TEOS, and may comprise tetraethyl orthosilicate or another dielectric compatible with subsequent cavity etch processes (e.g., BOE or other oxide etchants). The thickness of the stack resonator dielectric layer 1539 may be selected based on a target height for the next stacked conductive metal portions of the ring-aperture resonator (e.g., to extend the height of the pillar and/or planar-layer features upward by a desired amount).

FIG. 15I illustrates the initial stages of forming a stacked set of metallic features for a stack-integrated ring-aperture resonator. As shown, the underlying structure includes the reflector layer M11501 and the via layer 1502, with the via layer 1502 depicted in a simplified or “collapsed” form to conserve space. A stacked dielectric cap layer 1538 (SiN) and a stacked resonator dielectric layer 1539 (e.g., TEOS) are present above the previously formed first-stack metal features of the ring-aperture resonator structure. A patterned mask layer 1533 (e.g., a photoresist and/or hard mask) is formed on the upper surface of the stacked resonator dielectric layer 1539. The patterned mask layer 1533 defines the locations at which the stacked dielectric materials 1538, 1539 will be etched to create second-stack cavities for the next set of metal features. In this ring-aperture embodiment, the patterning is arranged such that, when viewed in plan view, the resulting cavities collectively correspond to a ring-aperture resonator geometry (i.e., features that will ultimately define an annular gap in which a tunable dielectric material may later be positioned), and the illustrated cross-section includes the beginnings of a first ring-aperture resonator as well as cut-off portions of neighboring resonators.

FIG. 15J illustrates the structure after etching the stacked resonator dielectric layer 1539 (e.g., TEOS) and the stacked dielectric cap layer 1538 (SiN) to form second-stack cavities for the pillars and planar layer portions of the ring-aperture resonator. In the illustrated cross-section, cavities 1541 and 1544 correspond to partial cavities for the electrically conductive metallic pillars of neighboring ring-aperture resonators that are adjacent to the illustrated ring-aperture resonator. The cavity 1540 corresponds to the cavity for the electrically conductive metallic pillar of the illustrated ring-aperture resonator (i.e., the cavity that will be filled to extend the central pillar vertically in the second stack). The cavities 1542 on either side of cavity 1540 correspond to cavities for the conductive metallic planar layer portions that surround the central pillar in the completed ring-aperture resonator. In plan view, these planar-layer cavities form the ring-shaped portion of the ring-aperture resonator around the pillar cavity 1540.

As shown, the cavities may have tapered sidewalls as a result of the etch profile (e.g., an anisotropic etch), and the etch is controlled such that the cavities extend through the stacked dielectric materials 1538, 1539 to reach and/or expose underlying metal surfaces from the first stack in regions where electrical continuity is desired for the stacked metal features while maintaining dielectric separation between the pillar cavity 1540 and the planar-layer cavities 1542 so that these metal features remain electrically isolated from one another across the annular-gap region. In various embodiments, depending on the etching approach used (ion beam, chemical etching, etc.), the walls may be tapered to varying degrees.

FIG. 15K illustrates the deposition of a copper-manganese alloy seed/barrier layer 1548 onto the exposed surfaces of the patterned cavities formed in FIG. 15J. In various embodiments, the copper-manganese alloy may be deposited using electroless deposition, sputtering, vapor deposition, and/or another deposition technique suitable for providing a conformal coating. As shown, the copper-manganese alloy layer 1548 coats the sidewalls and bottom surfaces associated with the cavities 1541, 1542, 1540, and 1544, including the regions in which the second-stack copper is intended to make contact with the underlying first-stack copper to form vertically continuous stack-integrated metallic optical elements. The copper-manganese alloy layer 1548 functions as a manganese-based barrier and seed layer to enable subsequent copper plating and filling. After a post-plating anneal, the manganese component forms a manganese-based self-forming barrier at copper/dielectric interfaces while maintaining copper-to-copper continuity at the intended stacked metal junctions.

FIG. 15L illustrates copper plating and fill 1549 used to form the second-stack metallic features of the ring-aperture resonator. After forming the copper-manganese alloy layer 1548, copper (or another suitable metal) is deposited and/or plated to fill the patterned second-stack regions and to form an overburden on the upper surface. In the illustrated embodiment, the copper fill 1549 forms second-stack extensions of the electrically conductive metallic pillars (including the partial neighboring pillars and the central pillar extension corresponding to cavity 1540) and second-stack portions of the conductive metallic planar layer (corresponding to the cavities 1542 on either side of the central pillar region). The remaining stacked resonator dielectric material 1539 (e.g., TEOS) between the plated metal regions defines the sacrificial gap-forming regions that preserve the intended spacing between the pillar features and the planar-layer features. After dielectric removal, the sacrificial dielectric regions correspond to the annular gap (ring aperture) region, which is later available to receive a tunable dielectric material.

FIG. 15M illustrates a post-plating anneal to form the manganese-based self-forming barrier (SFB), followed by chemical-mechanical planarization (CMP) of the plated metal, in a combined step depiction. During the anneal, manganese from the copper-manganese alloy layer 1548 diffuses toward oxygen in the adjacent dielectric materials, forming a manganese-containing oxide barrier (e.g., an Mn-Si-Ox barrier) along copper/dielectric interfaces, while manganese at intended copper-to-copper junctions between the newly formed second-stack copper and the underlying first-stack copper is diffused away so that the stacked copper regions form continuous stack-integrated metallic optical elements. After annealing, CMP removes the copper overburden and planarizes the top surface, leaving discrete second-stack metal features that are vertically continuous with corresponding first-stack metal features and separated by dielectric regions that preserve the intended annular-gap spacing. In the illustrated cross-section, the resulting metal features include a partial neighboring pillar 1550, a first portion of the planar conductive ring/planar layer 1555, the central pillar 1551 of the illustrated ring-aperture resonator, a second portion of the planar conductive ring/planar layer 1555 on the opposite side of the central pillar, and a partial neighboring pillar 1552. These features are shown above the via layer 1502 and reflector layer 1501, and the spacing between the pillar feature 1551 and the planar-layer features 1555 is maintained by the intervening sacrificial dielectric regions at this stage of the process.

FIG. 15N illustrates the second-stack structure after a dielectric removal process (e.g., a buffered oxide etch (BOE) and/or another oxide-selective etch) that removes the sacrificial dielectric material(s) previously occupying the gap-defining regions between the stack-integrated metal features. As shown, the removal of the stacked resonator dielectric material (e.g., TEOS 1539) and, in some embodiments, the stacked dielectric cap layer (e.g., SiN 1538) opens the gaps between the stack-integrated metallic optical elements, leaving the metal features 1550, 1555, 1551, 1555, and 1552 fully exposed and separated by voids/channels that define the ring-aperture resonator geometry. In the illustrated cross-section, the opened gaps between the central pillar 1551 and the planar-layer portions 1555 correspond to the annular gap of the ring-aperture resonator (which is ring-shaped in plan view), and the opened gaps adjacent to the partial neighboring pillars 1550 and 1552 correspond to the repeating array of adjacent ring-aperture resonators. In subsequent processing, these gaps may be partially filled with a tunable dielectric material (e.g., a liquid crystal) so that the ring-aperture resonator operates as a tunable optical resonator with a sub-wavelength gap region.

As described in FIGS. 15A-15N, a metasurface may be formed with stack-integrated ring-aperture resonators that extend to a height that is at least 1.5 times greater than the smallest width thereof, such that each stack-integrated ring-aperture resonator has a total aspect ratio of at least 1.5:1. A wide variety of aspect ratio combinations are possible. For example, a stack-integrated ring-aperture resonator having a total aspect ratio between 1:1 and 4:1, or higher, may be formed using (i) a base ring-aperture resonator with an aspect ratio between 0.25:1 and 2:1, and (ii) one or more stacked ring-aperture resonators that have respective aspect ratios between 0.25:1 and 2:1. In various embodiments, the target aspect ratio of the stack-integrated ring-aperture resonators may be selected for first-order resonance, second-order resonance, third-order resonance, or a higher-order resonance. In some specific embodiments, a metasurface may be formed with stack-integrated ring-aperture resonators configured for first-order resonance with aspect ratios between approximately 1.5:1 and 2.5:1.

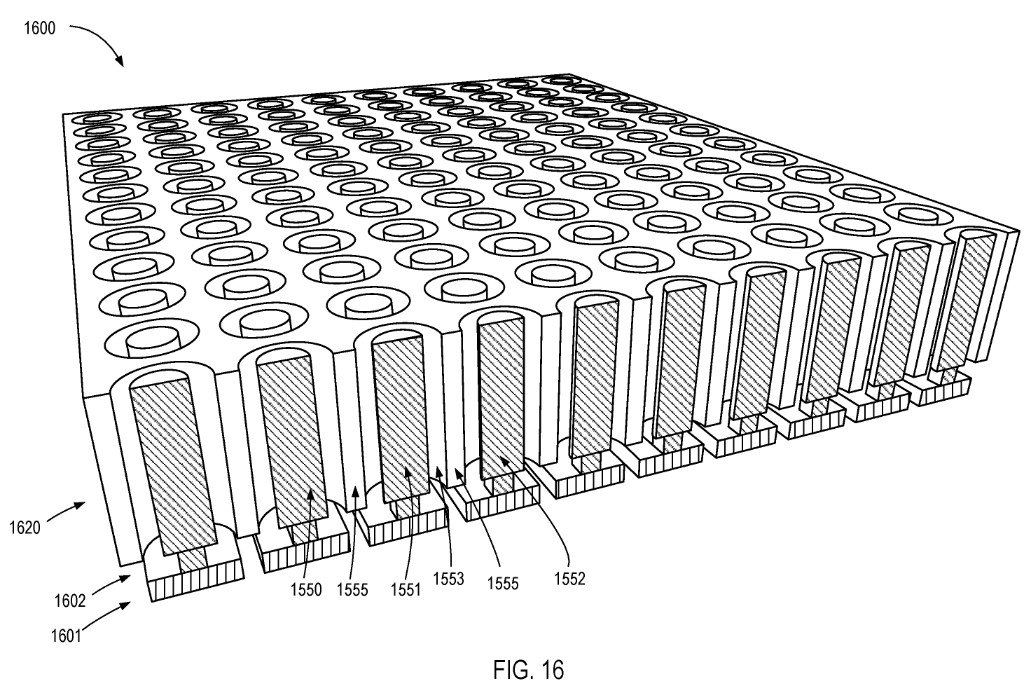

FIG. 16 illustrates a perspective view of a simplified block diagram of an optical metasurface 1600 that includes a resonator layer 1620 disposed above a via layer 1602 and an optical reflector layer 1601. The top surface of the resonator layer 1620 shows a two-dimensional array of ring-aperture optical resonators, where each resonator is characterized by a central, electrically conductive metallic pillar 1551 positioned within a corresponding aperture defined by a surrounding electrically conductive metallic planar layer 1555, with the pillar 1551 being electrically isolated from the planar layer 1555 to define a ring-shaped aperture (e.g., an annular gap) 1553 between the pillar 1551 and the planar layer 1555. In some embodiments, the ring-shaped aperture 1553 is configured to receive a tunable dielectric material (e.g., a liquid crystal or other tunable refractive-index material), such that applying a voltage differential between the pillar 1551 and the planar layer 1555 changes an effective refractive index within the ring-shaped aperture 1553 and thereby tunes a resonant optical response of the corresponding unit cell.

The cut-away portion along the front edge of FIG. 16 further illustrates how the metal features formed in the sequential stacking process of FIGS. 15A-15N appear in the completed metasurface 1600 as high-aspect-ratio, stack-integrated metallic optical elements. In particular, the metallic pillar 1551 and the metallic planar-layer portions 1555 correspond to the stack-integrated metal features formed during the ring-aperture resonator stacking sequence, with the planar-layer portions 1555 lying laterally adjacent to the pillar 1551 and collectively defining the ring-shaped aperture 1553 around the pillar 1551. The neighboring pillars 1550 and 1552, shown on either side of the illustrated unit cell, represent the corresponding metallic pillars of adjacent ring-aperture resonators within the array, demonstrating the repeating pillar/planar-layer geometry across the metasurface aperture.

As further illustrated, the via layer 1602 provides electrical coupling between the resonator-layer metal features (including the pillars 1550, 1551, 1552) and underlying conductive structures in the reflector layer 1601, enabling the resonator structures of the resonator layer 1620 to be biased and/or driven during operation while the reflector layer 1601 reflects incident optical radiation back toward the resonator layer 1620. In some embodiments, the via layer 1602 provides electrical coupling between the planar layer 1555 and the underlying conductive structures. In other embodiments, the planar layer 1555 may be biased or grounded from a lateral side or top surface.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. This disclosure should, therefore, be understood to encompass at least the following claims and all possible permutations thereof.

What is claimed:

1. An optical metasurface, comprising:
an optical reflector layer;
a resonator layer with an array of optical resonators that extend vertically with respect to the optical reflector layer, the resonator layer comprising conductive optical structures including stack-integrated metallic optical elements arranged to define a plurality of gaps therebetween,
wherein each stack-integrated metallic optical element comprises at least:
a base metallic optical element, and
a first stacked metallic optical element formed using a manganese-based self-forming barrier; and
a tunable dielectric material that has a tunable refractive index positioned within the gaps.

2. The metasurface of claim 1, wherein the base metallic optical element of each stack-integrated metallic optical element is formed during a first damascene manufacturing process, and
wherein the first stacked metallic optical element of each stack-integrated metallic optical element is formed during a subsequent damascene manufacturing process, and wherein at least the subsequent damascene manufacturing process is a single-damascene manufacturing process.

3. The metasurface of claim 1, wherein the base metallic optical element and the first stacked metallic optical element of each stack-integrated metallic optical element are joined to form a continuous metallic optical element.

4. The metasurface of claim 1, wherein each stack-integrated metallic optical element extends to a height that is at least 1.5 times greater than a smallest width thereof, such that each stack-integrated metallic optical element has an aspect ratio of at least 1.5:1.

5. The metasurface of claim 1, wherein each stack-integrated metallic optical element further comprises at least a second stacked metallic optical element formed using a manganese-based self-forming barrier, and wherein each stack-integrated metallic optical element has an aspect ratio of at least 3:1.

6. The metasurface of claim 1, wherein the tunable dielectric material comprises one or more of: liquid crystal, an electro-optic polymer, an electro-optical crystal, and chalcogenide glass.

7. The metasurface of claim 1, wherein the array of optical resonators of the resonator layer comprises a one-dimensional array of optical resonators, and wherein the stack-integrated metallic optical elements comprise elongated rectangular rails, the gaps comprising channels between adjacent rails.

8. The metasurface of claim 1, wherein the array of optical resonators of the resonator layer comprises a two-dimensional array of optical resonators, and wherein the stack-integrated metallic optical elements comprise rectangular prism pillars.

9. The metasurface of claim 8, wherein the rectangular prism pillars are rounded-edge rectangular prism pillars.

10. The metasurface of claim 1, wherein the conductive optical structures comprise an electrically conductive metallic planar layer having a plurality of apertures and a plurality of electrically conductive metallic pillars respectively positioned in the apertures and electrically isolated from the metallic planar layer to define ring-shaped apertures therebetween, wherein each metallic pillar comprises a respective stack-integrated metallic optical element.

11. The metasurface of claim 10, wherein each metallic pillar and each aperture have a circular cross-section, such that each ring-shaped aperture is annular.

12. The metasurface of claim 10, wherein each metallic pillar has a rounded-edge rectangular cross-section, and each aperture has a rounded-corner rectangular shape, such that each ring-shaped aperture is a rounded-corner annular aperture.

13. A method to manufacture an optical metasurface, comprising:
forming an optical reflector layer;
forming an interconnect layer above the optical reflector layer; and
forming a resonator layer with an array of optical resonators that extend vertically with respect to the optical reflector layer, the resonator layer comprising conductive optical structures including stack-integrated metallic optical elements arranged to define a plurality of gaps therebetween, wherein forming each stack-integrated metallic optical element comprises at least:
forming a base metallic optical element via a damascene process with a tantalum-based barrier layer,
forming a first stacked metallic optical element on top of the base metallic optical element via a subsequent damascene process with a manganese-based self-forming barrier (Mn-SFB), and
annealing to cause manganese associated with the Mn-SFB to form a manganese-silicon-oxide layer (MnSiOx) on sidewalls of the first stacked metallic optical element and to cause copper to join the base metallic optical element and the first stacked metallic optical element; and
positioning a tunable dielectric material that has a tunable refractive index within the gaps.

14. The method of claim 13, wherein the subsequent damascene process to form the first stacked metallic optical element is a single-damascene process.

15. The method of claim 13, wherein forming the first stacked metallic optical element comprises depositing the Mn-SFB as a copper-manganese alloy on sidewalls and a bottom of a cavity etched in a dielectric material prior to forming the first stacked metallic optical element.

16. The method of claim 13, wherein the tunable dielectric material comprises one or more of: liquid crystal, an electro-optic polymer, an electro-optical crystal, and chalcogenide glass.

17. The method of claim 13, wherein forming the resonator layer comprises forming the stack-integrated metallic optical elements as elongated rectangular rails arranged in a one-dimensional array, such that the gaps comprise channels between adjacent rails.

18. The method of claim 13, wherein forming the resonator layer comprises forming the stack-integrated metallic optical elements as pillars arranged in a two-dimensional array.

19. The method of claim 13, wherein forming the resonator layer comprises forming an electrically conductive metallic planar layer having a plurality of apertures, and forming electrically conductive metallic pillars respectively positioned in the apertures and electrically isolated from the metallic planar layer to define ring-shaped apertures therebetween, wherein each metallic pillar comprises a respective stack-integrated metallic optical element.

20. The method of claim 19, wherein each metallic pillar and each aperture have a circular cross-section such that each ring-shaped aperture is annular.

21. The method of claim 19, wherein each metallic pillar has a rounded-edge rectangular cross-section, and each aperture has a rounded-corner rectangular shape, such that each ring-shaped aperture is a rounded-corner annular aperture.

22. A method to form a stack-integrated metallic optical element comprising:
forming a base metallic optical element via a damascene process with a tantalum-based barrier layer; and
forming a first stacked metallic optical element on top of the base metallic optical element via a subsequent damascene process, wherein the subsequent damascene process includes:
depositing a manganese-based self-forming barrier (Mn-SFB), and
annealing the Mn-SFB to form a manganese-silicon-oxide layer (MnSiOx) on sidewalls of the first stacked metallic optical element and to cause copper to join the base metallic optical element and the first stacked metallic optical element.

23. The method of claim 22, wherein the stack-integrated metallic optical element comprises a metallic pillar configured to be positioned in a circular aperture of an electrically conductive metallic planar layer and electrically isolated from the metallic planar layer to define a ring-shaped aperture therebetween, wherein the metallic pillar has a circular cross-section.

24. The method of claim 22, wherein the stack-integrated metallic optical element comprises a metallic pillar configured to be positioned in a rounded-corner rectangular aperture of an electrically conductive metallic planar layer and electrically isolated from the metallic planar layer to define a ring-shaped aperture therebetween, wherein the metallic pillar has a rounded-edge rectangular cross-section.

25. The method of claim 22, wherein depositing the Mn-SFB comprises electrolessly depositing a copper-manganese alloy on sidewalls and a bottom surface of a cavity prior to forming the first stacked metallic optical element, and further comprising removing at least a portion of the MnSiOx layer from sidewalls of the first stacked metallic optical element using a buffered oxide etchant.
